(19) United States
(12) Patent Application Publication
(10) Pub. No.: US 2009/0053551 A1
(43) Pub. Date: Feb. 26, 2009

(54) Surface Treated Stainless Steel Sheet for Automobile Fuel Tank and for Automobile Fuel Pipe with Excellent Salt Corrosion Resistance and Weld Zone Reliability and Surface Treated Stainless Steel Welded Pipe for Automobile Fuel Inlet Pipe Excellent in Pipe Expandability

(76) Inventors: Shunji Sakamoto, Tokyo (JP); Yasuto Gotoh, Tokyo (JP); Masao Kurosaki, Tokyo (JP); Toshinori Mizuguchi, Tokyo (JP); Naoto Ono, Tokyo (JP)

Correspondence Address: KENYON & KENYON LLP, ONE BROADWAY, NEW YORK, NY, 10004, US

(21) Appl. No.: 12/224,455

(22) PCT Filed: Oct. 26, 2007
(86) PCT No.: PCT/JP2007/071359

§ 371 Date: Aug. 26, 2008

(30) Foreign Application Priority Data
Nov. 21, 2006 (JP) 2006-314725
Aug. 22, 2007 (JP) 2007-216195
Oct. 12, 2007 (JP) 2007-266715

(51) Int. Cl. B32B 15/18; B32B 1/08

(52) U.S. Cl. 428/603; 428/684

(57) ABSTRACT

The present invention provides surface treated stainless steel sheet for an automobile fuel tank or for a fuel pipe with excellent corrosion resistance and weld zone reliability in a salt environment and a surface treated stainless steel welded pipe for an automobile fuel inlet pipe, characterized by comprising a stainless steel sheet substrate having a predetermined composition of ingredients on the surface of which is provided a corrosion-proofing plating layer comprising Sn and unavoidable impurities and having a weight of 10 g/m² to 200 g/m² or a corrosion-proofing plating layer comprising Sn and Zn: 0.8 to 10.0 mass % and unavoidable impurities and having a weight of 10 g/m² to 200 g/m².

### TECHNICAL FIELD

The present invention relates to surface treated stainless steel sheet for an automobile fuel tank with excellent corrosion resistance and weld zone reliability in a salt environment and a surface treated stainless steel welded pipe for an automobile fuel inlet pipe with excellent pipe expandability.

### BACKGROUND ART

From the recent needs for protection of the environment and reduction of life cycle costs, fuel tanks, fuel pipes (“fuel inlet pipes” and “fuel lines”), and other fuel system parts have also been required to offer fuel barrier properties and longer life.

Automobile use fuel tanks and fuel pipes are required under American regulations to guarantee long lives of 15 years or 150,000 miles. Fuel system parts for satisfying this made of three materials, that is, plated ordinary steel materials, plastics, and stainless steel, are being developed.

Among these three materials of plated ordinary steel materials, plastics, and stainless steel, plastics have the problem of recyclability, while plated ordinary steel materials have concerns regarding durability with respect to the biofuels which will be spreading in the future. On the other hand, stainless steel has the advantages of ease of recycling as an iron-based material and sufficient corrosion resistance to biofuels and is already in commercial use as a material for fuel pipes.

However, stainless steel alone cannot necessarily be said to be sufficient in terms of corrosion resistance in a salt environment when used for a fuel tank or fuel pipe. That is, in a laboratory accelerated test simulating the case of exposure to road salt, SUS436L and other ferrite-based stainless steel suffer from crevice corrosion at the crevice structural parts or welded structural parts, while SUS304L and other austenite-based stainless steel have the problem of stress corrosion cracks at the weld zones etc. To overcome this problem, several corrosion-proofing technologies have been developed.

For example, Japanese Patent Publication (A) No. 2003-277992 discloses a corrosion-proofing method of painting the surface of a fuel tank formed from a ferrite-based stainless steel sheet by cationic electrodeposition, coating only the weld zone by a zinc-rich paint, or using as the steel sheet material a steel sheet formed with a plating layer comprising an Al plating layer, Zn plating layer, or a plating layer comprised of an alloy of Zn and one or more of Fe, Ni, Co, Mg, Cr, Sn, and Al.

Further, Japanese Patent Publication (A) No. 2004-115911 proposes a fuel tank formed from a stainless steel sheet and covered by a Zn-containing paint with a Zn content of 70% or less.

Further, Japanese Patent Publication (A) No. 2003-221660 proposes a fuel tank formed using a hot dip aluminum-plated ferrite-based or austenite-based stainless steel sheet having specific properties.

However, cationic electrodeposition painting is a method of dipping an object to be coated in a paint solution to electrodeposit it. The technology is actually being applied to fuel inlet pipes. Leaving aside small objects such as fuel inlet pipes, there is the problem that application is difficult for objects with a large buoyancy such as fuel tanks. Further, there is the problem that a sufficient corrosion-proofing effect cannot necessarily be obtained for crevices with small crevice openings and large depths.

Further, for zinc-rich paints, it is possible to suppress corrosion inside the crevices by the cathodic corrosion-proofing effect, but this type of Zn-containing paint contains a large amount of Zn and has a relatively small resin ingredient, so compared with general paint, the film adhesion tends to be poor. In particular, in harsh salt corrosion tests, sometimes a problem arises that the film blisters and, in extreme cases, the film peels off. If trying to improve the film adhesion, reducing the Zn content is one means, but if doing this, there is the problem that the originally aimed at cathodic corrosion-proofing effect ends up being largely destroyed.

On the other hand, for an aluminum-plated stainless steel sheet, while there is no problem with the stainless steel itself of the substrate, there is a problem that the aluminum of the plating layer is easily corroded by the currently spreading alcohol-containing fuels. The corrosion products of the aluminum causes critical trouble such as clogging of filters, spray devices, and other fuel feed system parts. Further, aluminum plating is usually formed by hot dipping. Since the treatment is performed at a relatively high temperature, a brittle alloy layer is formed at the time of hot dipping. At the stage of forming the fuel tank and fuel pipe, there is also the problem of peeling of the plating layer and press cracking starting from breakage of the alloy layer.

Technology not depending on this Al and Zn has also been disclosed. Japanese Patent Publication (A) No. 61-91390 discloses to give steel sheet containing Cr: over 3% to 20% and acid-soluble Al: 0.005 to 0.10% a plating layer of Sn or an Sn—Zn alloy through a diffusion coating layer of Ni, Co, or an Ni—Co alloy to improve the corrosion resistance with respect to alcohol. However, when plating a high Cr content steel sheet with a layer of a Sn or Sn—Zn alloy, cracks sometimes occur in the weld zone.

Further, fuel inlet pipes are already being made using SUS436L (17% Cr-1.2% Mo) and painted by cationic electrodeposition for mounting in actual vehicles. The increase in material costs due to soaring prices of Mo in recent years is being considered a problem. Materials not containing any expensive Mo or suppressing the Mo content to a low level and giving a corrosion resistance equal to SUS436L are being sought.

### DISCLOSURE OF THE INVENTION

The present invention has as its object the provision of a stainless steel sheet material for an automobile fuel tank and for an automobile fuel pipe superior in corrosion resistance under a salt environment and a surface treated stainless steel welded pipe for an automobile fuel pipe.

The inventors ran massive salt corrosion tests on various stainless steel materials. As a result, they concluded that to overcome the problems in local corrosion such as crevice corrosion or stress corrosion cracking at crevice structural parts formed by fastening or welding of attached parts or the heat affected zones of welding or soldering, cathodic corrosion-proofing using sacrificial anodes is essential.

As sacrificial anode materials exhibiting a cathodic corrosion-proofing effect under a salt environment, Zn, Al, and Mg are known. Even in the above-mentioned prior art as well, this has been proposed in the form of aluminum plating (Al) or zinc-rich paint (Zn). These metals are preferentially corroded, so the substrate is protected. If viewing the principle of cathodic corrosion-proofing, it is possible to say instead that these metals are more chemically active compared with the substrate. For this reason, the cathodic corrosion-proofing effect is maintained until the sacrificial anode material finishes being consumed. However, after finished being consumed, the corrosion-proofing effect can no longer be expressed. That is, when using a sacrificial anode material to prevent corrosion of a substrate by cathodic corrosion proofing, the consumption life of the sacrificial anode material governs the corrosion life of the fuel tank or fuel pipe.

To extend the consumption life, it is sufficient to increase the mass of the sacrificial anode material. It is sufficient to find the consumption rate of the sacrificial anode material in a test envisioning the harshest salt environment and give the fuel tank or fuel pipe a sufficient amount of the sacrificial anode so that it is not finished being consumed over 15 years. However, if using the Zn already known under this thinking, if speaking of a zinc-rich paint, it is necessary to secure a thick film over 100 μm. Even when plating Zn, thick plating over 50 μm becomes necessary. This condition cannot become grounds for selection of Zn as a practical sacrificial anode material. Mg is required in an amount equal to or greater than Zn and cannot be used in the form of a plating or a paint, so is harder to use than Zn. Al, compared with Zn and Mg, has a smaller consumption rate. An Al plating can promise a sufficient salt corrosion prevention effect even with a plating thickness of 10 μm or less. However, there are the problems of workability or corrosion due to the alcohol fuel explained above, so this is not suited for practical use. In particular, the latter problem is critical.

Therefore, it is necessary to discover sacrificial anodic materials other than the conventionally known Zn, Mg, and Al. These materials have to be sufficiently long in consumption life and be more electrochemically active than a stainless steel substrate under a salt environment. In addition, it is necessary that the inner surfaces of the fuel tank or fuel pipe not corrode much at all even in a fuel environment.

The inventors engaged in various studies and as a result obtained the discovery that, as the most suitable sacrificial anode material satisfying these conditions, Sn or a metal comprising mainly Sn and including a small, suitable quantity of Zn is most useful.

The inventors discovered that the main ingredient Sn of the sacrificial anode, unlike the case where the substrate is ordinary steel, exhibits a cathodic corrosion-proofing effect for stainless steel under a salt environment. Compared with Zn etc. enabling the same cathodic corrosion-proofing, there is the advantage that the consumption life is longer. It could be evaluated as a type of metal most useful for the object of the present invention of longer rust-proofing. Further, it could be evaluated as a type of metal enabling realization of a sufficient corrosion resistance of the inner surface of the fuel tank or fuel pipe even in a biofuel environment. Further, as embodiments as well, the point that the hot dipping method, which enables the amount of deposition required for long-term rust-proofing to be sufficiently secured, is industrially established could be evaluated as a major advantage in raising practical applicability. In addition, the inventors discovered that a Ni plating and Fe—Ni plating, which are preferably used as pretreatment when hot dipping stainless steel, as well, like Sn, are more electrochemically active than a stainless steel substrate in a salt environment and have sufficient corrosion resistance even in a degraded gasoline or biofuel environment containing organic acids. This can be evaluated as being able to guarantee that the corrosion resistance will not rapidly deteriorate due to exposure of Ni or Fe—Ni even after the Sn is consumed. These will be explained in more detail below.

The inventors first ran composite cycle corrosion tests simulating an actual salt environment (spraying of salt water: 5% NaCl spraying at 35° C.×2 Hr, drying: relative humidity 20%, 60° C.×4 Hr, moistening: relative humidity 90%, 50° C.×2 Hr repeated) during which they learned that the stage where a metal material is corroded the most is the drying step or the moistening step after drying. As the environmental conditions which the surface of the metal material is exposed to in this process, the chloride concentration reaches saturation and the temperature also becomes high. Based on this, the inventors measured the corrosion potential of various metal materials in a 50° C. saturated NaCl solution. Examples of the results are shown in FIG. 1.

The corrosion potential of 17% Cr-based stainless steel is 0 to +0.1V vs. SCE. Sn exhibits a value of −0.55V vs. SCE or so or lower than stainless steel. This means that when bringing stainless steel and Sn into contact, the Sn acts as a sacrificial anode and the stainless steel is made corrosion-proof. Zn has a corrosion potential of −1.0V vs. SCE or so which is a potential sufficiently lower than stainless steel. An Sn-8Zn alloy comprised of Sn containing Zn in an amount of 8% exhibits a potential of an equal level to the −1.0V vs. SCE or so of Zn at the start of the test, but along with the consumption of the Zn, it approaches the corrosion potential of Sn. Al also has a corrosion potential of −0.8V vs. SCE or so which is a potential sufficiently lower than stainless steel. Ni also exhibits a value of −0.2V vs. SCE or so which is lower than the potential of stainless steel. Due to these, all of Sn, Zn, Sn-8Zn, Al, and Ni can be said to be chemically active compared with 17Cr-based stainless steel. It is clear that they exhibit a sacrificial corrosion-proofing action.

On the other hand, ordinary steel has a corrosion potential of −0.7V vs. SCE or so. If comparing this value with the potentials of Zn, Al, Ni, and Sn, the order of the potentials becomes Ni>Sn>ordinary steel>Al and Zn. Sn and Ni do not act as sacrificial anodes for ordinary steel. Not only that, but it became clear that they conversely promote the corrosion of ordinary steel.

In this way, unlike the action against ordinary steel, Sn or an Sn—Zn alloy and in turn even Ni have a sacrificial corrosion effect with respect to stainless steel. Therefore, by arranging these metals at the stainless steel substrate, it is possible to prevent corrosion of the substrate. However, if these sacrificial anode materials are consumed in a short period, the effect cannot be said to be sufficient.

Therefore, in addition to measuring the corrosion potential, the inventors measured the corrosion rates of various metal materials in the state with a battery formed with the stainless steel in a 50° C. saturated NaCl solution. Examples of the results are shown in FIG. 2.

The corrosion rate of Sn is extremely low in level or about the same extent as Al. On the other hand, it is clear that Zn is severely corroded in a salt environment. The inventors obtained composite cycle test data of various types of metal sheets and discovered the correlation between the corrosion loss life of composite cycle tests and the above corrosion rate data. Using this correlation, the inventors set the allowable corrosion rate in a 180-day composite cycle corrosion test, by which it is judged that 15 years of rust-proofing can be achieved, required so as not to be consumed completely in the test, at 0.12 μm/hr. The corrosion rate of Sn is a value about one-third of this. Sufficiently satisfactory corrosion resistance was obtained. On the other hand, Zn far exceeds this allowable value. To prevent Zn from being consumed completely in a half-year composite cycle corrosion test, a thickness of at least over 50 μm becomes necessary. This is not practical. Al exhibits a corrosion rate of about the same extent as Sn. When speaking limited to the problem of salt corrosion, it can be said to be useful as a sacrificial anode material, but the corrosion resistance of the inner surface of a fuel tank or fuel pipe with respect to an alcohol fuel is insufficient, so it cannot be said to be practical.

Zn has the difficulty of too large a corrosion rate. It has not only the effect of just lowering the potential, but also the effect of the corrosion products of Zn raising the pH of a corrosive liquid under repeated drying conditions to suppress the corrosion. From this, the inventors considered that an Sn—Zn-based alloy based on Sn and containing a suitable quantity of Zn would also useful. They seam welded samples of 17Cr-based stainless steel sheet plated with an Sn—Zn alloy and used them for composite cycle corrosion tests to evaluate the corrosion proofing. The results are shown in FIG. 3. If the Zn content exceeds 10%, the corrosion of Zn becomes dominant. The plating layer is quickly consumed, so the corrosion proofing is insufficient, but an Sn—Zn alloy with a Zn content of 1 to 10% realizes a corrosion proofing of a level equal to or better than that of Sn.

If providing Sn or an Sn—Zn alloy for a stainless steel substrate by the plating method, a weight of 10 g/m² or more is necessary to secure a corrosion resistance in the above half year composite cycle corrosion test. To industrially secure this plating weight, the inventors concluded hot dipping was suitable.

Next, the inventors studied the corrosion properties of an Sn-based plating metal with respect to not only a salt environment, but also degraded gasoline or alcohol fuel. They measured the corrosion rate in a 50° C. solution containing 0.01% formic acid and 0.01% acetic acid and 0.01% NaCl and a 60° C. ethanol solution containing 3% water. Examples of the results are shown in FIG. 4.

Al is severely corroded in ethanol, while Zn has a problem with corrosion in an environment containing an organic acid. On the other hand, Sn has a small corrosion rate in an ethanol environment of course and also in a degraded gasoline environment, so a satisfactory corrosion resistance is obtained. If the Sn—Zn-based alloy becomes greater in content of Zn, the corrosion of the Zn in the alloy becomes a problem, but if the content is 10% or less, a corrosion resistance of a level almost equal to Sn is obtained. For avoiding the problem of clogging in the filters, spray parts, and other parts of the fuel feed system, the corrosion rate must be made as low a level as possible. As the allowable value, the inventors set an upper limit value of 10 mg/m²/hr based on the corrosion rate of a conventionally used terne metal (Pb—Sn alloy) in a 50° C. aqueous solution containing 0.01% formic acid and 0.01% acetic acid and 0.01% NaCl simulating a degraded gasoline (non-alcohol) environment. Note that stainless steel itself does not suffer from corrosion in that environment.

In this way, it became clear that hot dipping of Sn or an Sn—Zn alloy eliminates the problem of salt corrosion of stainless steel.

However, the Sn or Sn—Zn alloy plated on a stainless steel substrate causes another problem. The problem is weld cracks. That is, if seam welding, projection welding, spot welding, TIG welding, MIG welding, high frequency welding, or soldering in the state plated with Sn or Sn—Zn alloy, cracks occur in the weld zone or soldered parts. The seam welding, projection welding, spot welding, TIG welding, MIG welding, high frequency welding, or soldering are essential steps in the production of a fuel tank or fuel pipe. If cracks occur at this time, no matter how much salt corrosion can be prevented in the material and, further, no matter how superior the alcohol corrosion resistance, the material cannot be used as a material for a fuel tank or fuel pipe.

The inventors engaged in intensive research and as a result learned that this cracking is so-called liquid metal embrittlement where the Sn or Sn—Zn alloy liquefied by the input heat at the time of welding or soldering enters the grain boundaries of the substrate formed into coarse grains by the heat affect to lower the grain boundary strength and opens from the surface of the substrate heat affected zones under the condition of the tension residual stress applied along with the temperature drop to cause cracking. Inherently, it is critical that Sn or an Sn—Zn alloy be a low melting point metal, but liquid metal embrittlement is considered to differ in sensitivity depending on the combination of the material and the type of liquid metal. Regarding stainless steel, the liquid metal embrittlement due to Sn is not known at all. The inventors searched for the relationship with crack sensitivity from the viewpoint of the alloy composition of a stainless steel substrate. That is, they used sheet materials of stainless steel substrates of several types of alloy compositions and hot dipped in Sn for seam welding and evaluated them for the presence of cracking. As a result, it became clear that in steel containing only Cr, no cracks occurred, while if the content of Ni was large, cracks easily occurred. The inventors discovered that the crack sensitivity depends on the steel composition. Based on this, the inventors used major stainless steel materials changed in composition of the alloy for additional seam welding tests and determined the conditions of the steel compositions required for preventing cracking as a regression equation of the contents of the alloy elements. That is, as shown in FIG. 5, the steel composition of the stainless steel substrate has to have an Y-value defined by formula (1) satisfying the condition of −10.4 or less:

Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

The mechanism for liquid metal embrittlement by Sn is not necessarily clear, but the elements increasing the Y-value in formula (1) are all austenite stabilizing elements, while the elements reducing the Y-value are all ferrite stabilizing elements. Further, the coefficients of the elements in formula (1) substantially match the order of the phase stabilization ability, so it is believed the embrittlement sensitivity is dominated by the phase balance of the ferrite and austenite. That is, the ease of entry of liquid Sn differs by the three factors of the ferrite/ferrite grain boundaries, ferrite/austenite grain boundaries, and austenite/austenite grain boundaries, so it is believed that the crack sensitivity is affected by the difference in the phase balance. It is deemed that the smaller the austenite phase and the greater the ferrite phase, the greater the resistance of a material to liquid metal embrittlement of Sn.

However, even if the Y-value calculated from the main alloy elements is a predetermined value, if the contents of the impurity elements P and S are high, liquid metal embrittlement crack sensitivity is not completely eliminated. That is, as shown in FIG. 6, when the P content exceeds 0.050% or when the S content exceeds 0.010%, cracks are observed. These elements are believed to have the action of lowering the grain boundary strength. Therefore, it is first by the Y-value satisfying a predetermined condition and the contents of P and S being set to allowable limit levels or less that a material for a fuel tank or fuel pipe application satisfying the weld zone reliability without suffering from liquid metal embrittlement even with Sn-based plating can be obtained.

Further, as a property which should be stressed in the process of working the material into a fuel tank, the press workability may be mentioned. The press formability and other aspects of cold workability are determined by the material properties of the material itself and the sliding resistance of the material surface as dominant factors. Sn is a soft metal, so an Sn-based plating layer surface is sufficiently small in sliding resistance. For this reason, there is the advantage that the cold workability which the stainless steel substrate should be provided with is eased compared with unplated stainless steel sheet. Based on this, material properties required for the substrate are set predicated on the presence of an Sn-based plating layer.

Further, in working a material into a fuel inlet pipe, the material is expanded and bent. For pipe expandability, in addition to the material properties of the substrate, in the same way as naked ferrite-based stainless steel welded pipe, it is important to set the hardnesses of the matrix material and weld zone and the balance of strength due to the weld bead thickness to suitable ranges and to secure circumferential direction elongation of the welded pipe matrix material part. That is, the inventors rolled various types of Sn plated or Sn—Zn plated 0.8 mmt stainless steel strips to produce 25.4 mmφ seam welded pipes under various pipe-making conditions, straightening conditions after pipe-making, and weld bead cutting conditions, used lubrication oil of a dynamic viscosity of 100 mm²/s (40° C.) or so for coaxial pipe expansion by a punch of a taper angle of 20° to outside diameters of 30φ, 38φ, 45φ, and 51φ and off-centered pipe expansion by an offset amount of 6 mm to 51φ, that is, five steps, and evaluated the pipe expandability by the presence of any cracks in the entire process. As a result, as shown in FIG. 7 and FIG. 8, by defining the hardness difference ΔHv (=Hv_{W}−Hv_{M}) of the Vicker's hardness Hv_{W} of the weld zone and the Vicker's hardness Hv_{M} of the matrix material part as 10 to 40 in range and the ratio RT (=T_{W}/T_{M}) of the bead thickness T_{W} of the weld zone and the wall thickness T_{M} of the matrix material as 1.05 to 1.3 in range and by defining the circumferential direction elongation of the welded pipe matrix material after shaping, welding, and straightening as 15% or more, it is possible to obtain surface treated stainless steel welded pipe enabling expansion to 2 times or more the original pipe and off-centered pipe expansion.

The present invention was made based on the above discoveries and has as its gist the following:

(1) Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.030%, Si: ≦2.00%, Mn: ≦2.00%, P: ≦0.050%, S: ≦0.0100%, N: ≦0.030%, Al: 0.010 to 0.100%, and Cr: 10.00 to 25.00%, further containing one or more of Ni: 0.10 to 4.00%, Cu: 0.10 to 2.00%, Mo: 0.10 to 2.00%, and V: 0.10 to 1.00% and one or both of Ti: 0.01 to 0.30% and Nb: 0.01 to 0.30%, having a balance of unavoidable impurities and Fe, and having a Y-value defined by formula (1) of −10.4 or less, on the surface of which is provided a corrosion-proof plating layer comprised of Zn: 0.8 to 10.0% and a balance of Sn and unavoidable impurities in a weight of 10 g/m² to 200 g/m²:

Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

(3) Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦1.00%, Mn: ≦1.00%, P: ≦0.050%, S: ≦0.0100%, N: ≦0.0200%, Al: 0.010 to 0.100%, and Cr: 10.00 to 25.00%, further containing one or both of Ti and Nb satisfying (Ti+Nb)/(C+N): 5.0 to 30.0, having a balance of unavoidable impurities and Fe, and having a Y-value defined by formula (1) of −10.4 or less, on the surface of which is provided a corrosion-proof plating layer comprised of Sn and unavoidable impurities in a weight of 10 g/m² to 200 g/m²:

Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

(4) Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦1.00%, Mn: ≦1.00%, P: ≦0.050%, S: ≦0.0100%, N: ≦0.0200%, Al: 0.010 to 0.100%, and Cr: 10.00 to 25.00%, further containing one or both of Ti and Nb satisfying (Ti+Nb)/(C+N): 5.0 to 30.0, having a balance of unavoidable impurities and Fe, and having a Y-value defined by formula (1) of −10.4 or less, on the surface of which is formed a corrosion-proof plating layer comprised of Zn: 0.8 to 10.0% and a balance of Sn and unavoidable impurities by the hot dipping method in a weight of 10 g/m² to 200 g/m²:

Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

(5) Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦0.60%, Mn: ≦0.60%, P: ≦0.040%, S: ≦0.0050%, N: ≦0.0150%, Al: 0.010 to 0.100%, and Cr: 10.00 to 25.00%, further containing one or more of Ti and Nb satisfying (Ti+Nb)/(C+N): 5.0 to 30.0, having a balance of unavoidable impurities and Fe, and having a Y-value defined by formula (1) of −10.4 or less, on the surface of which is provided a corrosion-proof plating layer comprised of Sn and unavoidable impurities in a weight of 10 g/m² to 200 g/m²:

Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

(6) Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦0.60%, Mn: ≦0.60%, P: ≦0.040%, S: ≦0.0050%, N: ≦0.0150%, Al: 0.010 to 0.100%, and Cr: 10.00 to 25.00%, further containing one or both of Ti and Nb satisfying (Ti+Nb)/(C+N): 5.0 to 30.0, having a balance of unavoidable impurities and Fe, and having a Y-value defined by formula (1) of −10.4 or less, on the surface of which is provided a corrosion-proof plating layer comprised of Zn: 0.8 to 10.0% and a balance of Sn and unavoidable impurities in a weight of 10 g/m² to 200 g/m²:

Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

(7) Surface treated stainless steel sheet for an automobile fuel tank and for an automobile fuel pipe with excellent corrosion resistance and weld zone reliability in a salt environment comprised of the stainless steel sheet substrate as set forth in any one of (1), (3), and (5) further containing, by mass %, B: 0.0002 to 0.0020%.

(8) Surface treated stainless steel sheet for an automobile fuel tank and for an automobile fuel pipe with excellent corrosion resistance and weld zone reliability in a salt environment comprised of the stainless steel sheet substrate as set forth in any one of (2), (4), and (6) further containing, by mass %, B: 0.0002 to 0.0020%.

(9) Surface treated stainless steel sheet for an automobile fuel tank and for an automobile fuel pipe with excellent corrosion resistance and weld zone reliability in a salt environment comprising a stainless steel sheet substrate containing, by mass %, containing C: ≦0.0100%, Si: ≦0.60%, Mn: ≦0.60%, P: ≦0.040%, S: ≦0.0050%, N: ≦0.0150%, Al: 0.010 to 0.100%, and Cr: 10.00 to 25.00%, further containing one or more of Ti and Nb satisfying (Ti+Nb)/(C+N): 5.0 to 30.0, having a balance of unavoidable impurities and Fe, having a Y-value defined by formula (1) of −10.4 or less, having a ferrite single phase metal structure, having an average r-value of 1.4 or more, and having a total elongation of 30% or more, on the surface of which is provided a corrosion-proof plating layer comprised of Sn and unavoidable impurities in a weight of 10 g/m² to 200 g/m²:

Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

(10) Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦0.60%, Mn: ≦0.60%, P: ≦0.040%, S: ≦0.0050%, N: ≦0.0150%, Al: 0.010 to 0.100%, and Cr: 10.00 to 25.00%, further containing one or both of Ti and Nb satisfying (Ti+Nb)/(C+N): 5.0 to 30.0, having a balance of unavoidable impurities and Fe, having a Y-value defined by formula (1) of −10.4 or less, having a ferrite single phase metal structure, having an average r-value of 1.4 or more, and having a total elongation of 30% or more, on the surface of which is provided a corrosion-proof plating layer comprised of Zn: 0.8 to 10.0% and a balance of Sn and unavoidable impurities in a weight of 10 g/m² to 200 g/m²:

Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

(11) Surface treated stainless steel sheet for an automobile fuel tank and for an automobile fuel pipe with excellent corrosion resistance and weld zone reliability in a salt environment as set forth in any one of (1) to (10), characterized in that said corrosion-proofing layer has a chemical conversion film formed on it.

(12) Surface treated stainless steel sheet for an automobile fuel tank and for an automobile fuel pipe with excellent corrosion resistance and weld zone reliability in a salt environment as set forth in any one of (1) to (11), characterized in that said corrosion-proofing layer or chemical conversion film has a water soluble lubrication film with a friction coefficient of 0.15 or less formed on it.

(13) Surface treated stainless steel welded pipe for an automobile fuel inlet pipe with excellent pipe expandability comprised of welded pipe made of surface treated stainless steel sheet as set forth in (9) or (10) having a hardness difference ΔHv (=Hv_{W}−Hv_{M}) of a Vicker's hardness Hv_{W} of a weld zone and a Vicker's hardness Hv_{M} of a matrix material of 10 to 40 in range and having a ratio RT (=T_{W}/T_{M}) of a bead thickness T_{W} of the weld zone and a wall thickness T_{M} of the matrix material of 1.05 to 1.3.

(14) Surface treated stainless steel welded pipe for an automobile fuel inlet pipe with excellent pipe expandability as set forth in (13), characterized in that the welded pipe after shaping, welding, and straightening has a circumferential direction elongation of the matrix material of 15% or more.

### BRIEF DESCRIPTION OF THE DRAWINGS

FIG. 1 shows the results of measurement of the corrosion potential of various types of metal materials in a 50° C. NaCl saturated aqueous solution simulating a salt environment.

FIG. 2 shows the results of conversion of a galvanic couple current between various types of metal materials and stainless steel in a 50° C. NaCl saturated aqueous solution simulating a salt environment to a corrosion rate.

FIG. 3 shows the results when finding the amount of corrosion of an Sn or Sn—Zn alloy plating test piece by a composite cycle corrosion test, that is, the effects of the Zn content in the plating metal on the corrosion resistance.

FIG. 4(a) is a view showing the results when finding the corrosion rate of various types of metal materials of the inner surface of a fuel tank or fuel pipe in a degraded gasoline environment.

FIG. 4(b) is a view showing the results when finding the corrosion rate of various types of metal materials in an ethanol environment.

FIG. 5 shows the results when seam welding an Sn-based plated stainless steel sheet, then evaluating the presence of liquid metal embrittlement cracks in a weld heat affected zone, that is, the effects of the Y-value calculated from the main alloy element content of the steel sheet.

FIG. 6 shows the results when seam welding an Sn-based plated stainless steel sheet, then evaluating the presence of liquid metal embrittlement cracks in a weld heat affected zone, that is, the effects of the P and S content of the steel sheet.

FIG. 7 shows the relationship among the state of expansion of a welded pipe, the hardness difference ΔHV (=HV_{W}−HV_{M}) of the Vicker's hardness HV_{W} of the weld zone and the Vicker's hardness HV_{M} of the matrix material part, and the ratio RT (=T_{W}/T_{M}) of the bead thickness T_{W} of the weld zone and the wall thickness T_{M} of the matrix material part.

FIG. 8 shows the relationship between the circumferential direction elongation of a welded pipe and the buckling and cracking in off-centered pipe expansion.

FIG. 9 shows the shape of a tank used for a press forming test, that is, shows the state when separately press forming an upper shell and lower shell, then mating the flange parts of the two and seam welding the broken line parts. An actual tank is then joined with a pump retainer, valve retainer, fuel inlet pipe, and other parts by welding or soldering to finish it, but FIG. 9 shows the state one step before this final shape.

FIG. 10 is a view showing the shape of the fuel inlet pipe used for the salt corrosion resistance test. The inventors obtained cut samples from the soldered part and the stay fitting contact part for use for corrosion tests.

### BEST MODE FOR CARRYING OUT THE INVENTION

First, the surface treated stainless steel sheet for a fuel tank and fuel pipe in the present invention will be explained.

Regarding the ingredients of the stainless steel sheet substrate, as the material for fuel system parts in the present invention, use was made of stainless steel sheet containing Cr: 10.00 to 25.00%. Cr is the main element governing the corrosion resistance of a material. If less than 10.00%, even if performing Sn-based plating, a sufficient salt corrosion resistance cannot be obtained. Even if performing Sn-based plating, the plating will be damaged at locations receiving a heat affect due to seam welding, projection welding, spot welding, TIG welding, MIG welding, high frequency welding, or soldering. The corrosion resistance of these locations under a salt environment has to be guaranteed by sacrificial dissolution of the plating layer around those locations, but if the amount of Cr of the substrate ends up falling below 10.00%, the potential difference of the Sn and substrate will become small where the corrosion potential of the substrate is near the corrosion potential of Sn or the potential of the substrate will end up becoming lower than the potential of the Sn, so the sacrificial corrosion effect will no longer be expressed. Further, a similar phenomenon will occur even in an inner surface corrosion environment containing an organic acid etc. Therefore, one of the requirements of steel ingredients which a stainless steel substrate should be provided with is having a Cr content of 10.00% or more. On the other hand, regarding the upper limit of the content of Cr, the content should be limited from the viewpoint of the drop of the press formability and other cold workability and rise of the material costs. 25.00% is the practical limit.

In addition, the contents of the main alloy elements other than Cr have to be adjusted so that the Y-value defined by formula (1) becomes −10.4 or less. This becomes the most important requirement of the material in the present invention predicated on Sn-based plating. That is, this condition is a requirement of the steel ingredients required for avoiding cracks due to liquid metal embrittlement in the welding or soldering step essential for forming a fuel tank or forming a fuel pipe. If the Y-value exceeds −10.4, since Sn or Zn have low melting points, cracks end up occurring at the weld heat affected zones due to liquid metal embrittlement. For this reason, the Y-value has to be limited to −10.4 or less.

The reasons for definition of the contents of the alloy elements included in formula (1) are as follows:

C and N: C and N are elements lowering the ductility of steel sheet and degrading the press forming or other cold workability and causing grain boundary corrosion at the weld zones or soldered parts. In addition, they are austenite stabilizing elements and have the action of increasing the Y-value. Therefore, the contents of these elements have to be limited to the lowest levels possible. The upper limits of C and N are made 0.030%. If considering the balance with the other elements affecting the Y-value, the upper limit of C is preferably made 0.0100%. The preferable upper limit of N is 0.0200%, more preferably 0.0150%.

Si: Si is a ferrite stabilizing element and has the action of reducing the Y-value and suppressing liquid metal embrittlement, but degrades the ductility of the steel sheet, so should not be contained in a large amount. The upper limit is made 2.00%, preferably 1.00%. More preferably, the upper limit should be limited to 0.60%.

Mn: Mn is an element degrading the ductility of steel sheet. It is an austenite stabilizing element increasing the Y-value, so the upper limit of the content is limited to 2.00%, preferably 1.00%. More preferably, the upper limit should be limited to 0.60%.

Ni: Ni, like Mn, is an austenite stabilizing element. It increases the Y-value, but the effect is larger than Mn. For this reason, the upper limit of the content is made 4.00%. On the other hand, Ni is an element useful for raising the corrosion resistance of a steel sheet substrate, so may be included in pursuit of a higher corrosion resistance. The lower limit content in this case is made 0.10%.

Cu: Cu, like Ni, is an austenite stabilizing element. It increases the Y-value, so the upper limit of the content is made 2.00%. Further, Cu, like Ni, has an effect smaller than Ni. This is an element useful for raising the corrosion resistance of a steel sheet substrate, so may be included in pursuit of a higher corrosion resistance. The lower limit content in this case is made 0.10%.

Mo: Mo, like Si, is a ferrite stabilizing element. It reduces the Y-value, but if included in a large amount, degrades the ductility of the substrate. For this reason, the upper limit of the content is made 2.00%. Note that in the case of a fuel pipe application, the upper limit of the content is preferably made 0.60% from the viewpoint of the cost restrictions compared with SUS436L. On the other hand, Mo is also an extremely useful element for improving the corrosion resistance of the substrate, so may also be included in pursuit of a higher corrosion resistance. The lower limit content in this case is made 0.10%.

V: V, like Mo, is a ferrite stabilizing element. It causes a reduction of the Y-value, but if included in a large amount, the ductility of the substrate deteriorates. For this reason, the upper limit of the content is made 1.00%. On the other hand, V, like Mo, is an element useful for improving the corrosion resistance of the substrate, so may be included in pursuit of a higher corrosion resistance. The lower limit content in this case is made 0.10%.

Al: Al is useful as a deoxidizing element. It reduces the Y-value of the ferrite stabilizing element, so is included in a suitable quantity. A range of content of 0.010 to 0.100% was deemed suitable.

Ti and Nb: Ti and Nb are ferrite stabilizing elements and reduce the Y-value. They have the action of fixing the C and N as carbonitrides and suppressing grain boundary corrosion. For this reason, at least one of Ti and Nb is included to a lower limit of 0.01%. On the other hand, since these are harmful to the ductility of the steel sheet substrate, the upper limit of the content is made 0.30%. As suitable contents of Ti and Nb, five to 30 times the content of the total of C and N is desirable.

Among these major elements, the contents of P, S, and B are defined for the following reasons.

P: This is an element segregating at the grain boundary, lowering the grain boundary strength, and raising the liquid metal embrittlement crack sensitivity. It is one of the elements for which handling is extremely important in the present invention. Further, it is also an element causing degradation of the ductility of the steel sheet substrate. For this reason, the content of P is preferably as low a level as possible. The upper limit of the allowable content is made 0.050%. The preferable upper limit of P is 0.040%, more preferably 0.030%.

S: In the same way as P, this is an element raising the liquid metal embrittlement crack sensitivity and one of the elements for which handling is extremely important in the present invention. Further, it is also an element causing deterioration of the corrosion resistance of the steel sheet substrate. For this reason, the content of S is preferably as low a level as possible. The upper limit of the allowable content is made 0.010%. The upper limit value of the preferable S content is 0.0050%, more preferably 0.0030%.

B: This is useful as an element raising the resistance to low temperature embrittlement or secondary working embrittlement. However, if included in a large amount, borides precipitate and the corrosion resistance deteriorates. For this reason, the suitable quantity in the case of inclusion is made 0.0002 to 0.0020% in range.

Further, said stainless steel sheet preferably satisfies the condition of formula (1) and has a ferrite single phase metal structure. The reason is that, as explained above, a ferrite structure has resistance to liquid metal embrittlement of Sn. Further, if becoming a mixed structure of a martensite phase and ferrite transformed from an austenite phase or austenite, adjustment of the mechanical properties becomes difficult and the press formability or other cold workability deteriorates. Further, as an additional reason, the point that an austenite phase exhibits stress corrosion crack sensitivity in a chloride environment may be mentioned. From this point as well, the austenite phase is preferably avoided.

Further, the material properties of said ferrite-based stainless steel sheet preferably, from the viewpoint of the press formability, include the two requirements of an average r-value of 1.4 or more and a total elongation of 30% or more both being satisfied. Steel sheet where even one requirement among these is not satisfied easily cracks at the time of press forming or pipe expansion, so the shape of the part has to be changed so that the working degree becomes milder or lubrication devised or other measures taken.

Note that said material properties are found by tensile tests using No. 13B test pieces defined in JIS Z 2201. The total elongation is found from the amount of change of the distance between standard points before and after the tensile tests. The average r-value is defined as (r_{L}+r_{C}+2r_{D})/4, while r_{L}, r_{C}, and r_{D} are the Rankford values in the rolling direction, the direction perpendicular to the rolling direction, and the direction at a 45 degree angle with respect to the rolling direction. The work hardening rates are found by measuring the stresses when imparting 30% and 40% tensile strain and calculating the slant between two points.

Next, the corrosion-proof plating applied to the stainless steel sheet satisfying the above conditions will be explained.

The metal used for the corrosion-proof plating is electrochemically baser than said stainless steel and must provide a sacrificial corrosion effect. A fuel tank or a fuel pipe is seam welded, projection welded, spot welded, or soldered, but the plating is lost at the locations receiving the heat affect due to these. To secure corrosion resistance of the lost plating locations under a salt environment, there is no choice but to rely on the sacrificial corrosion effect of the plating layer around those locations.

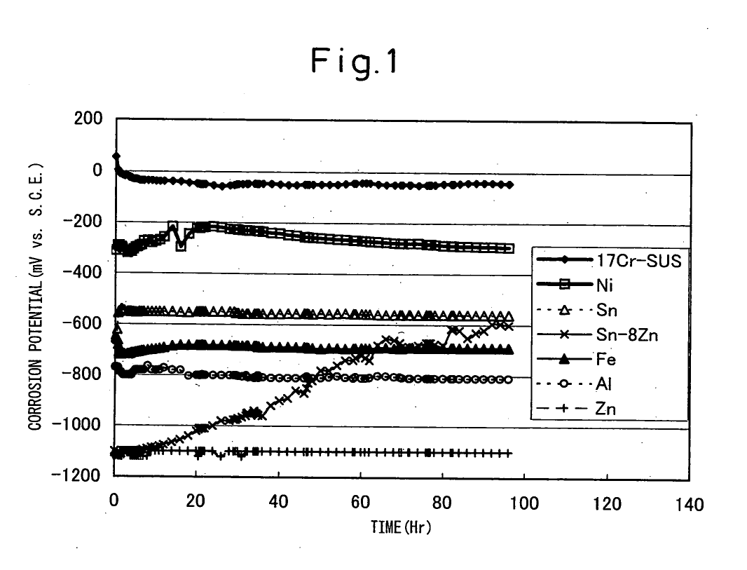

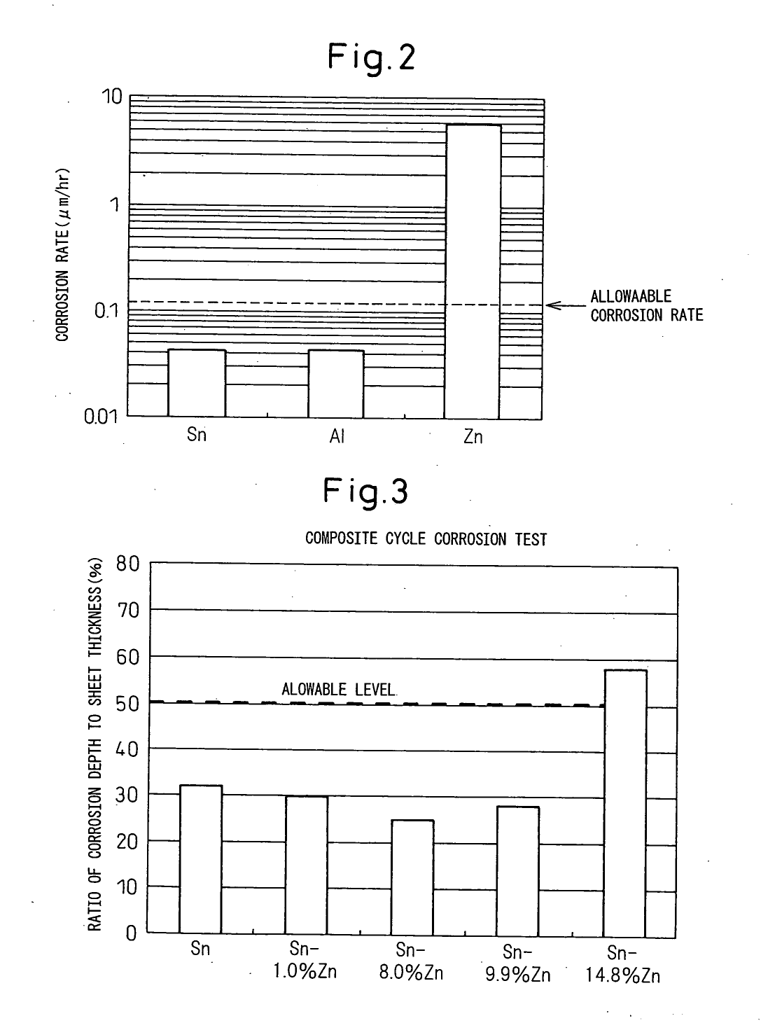

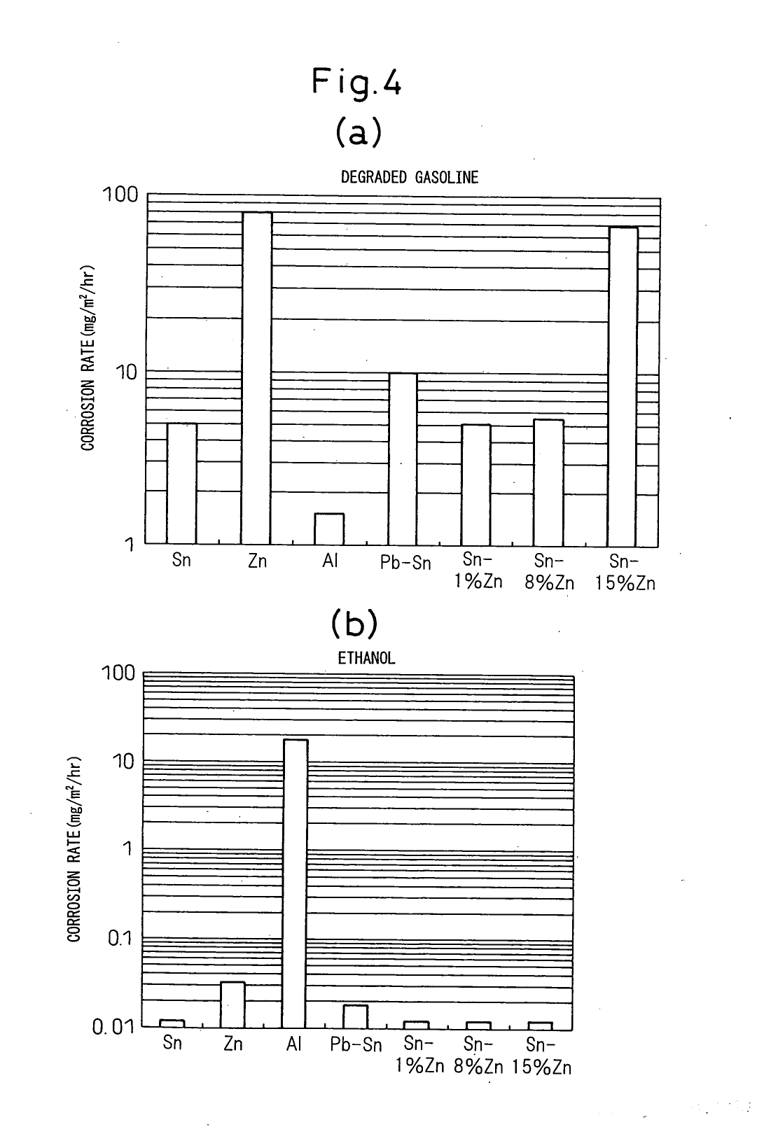

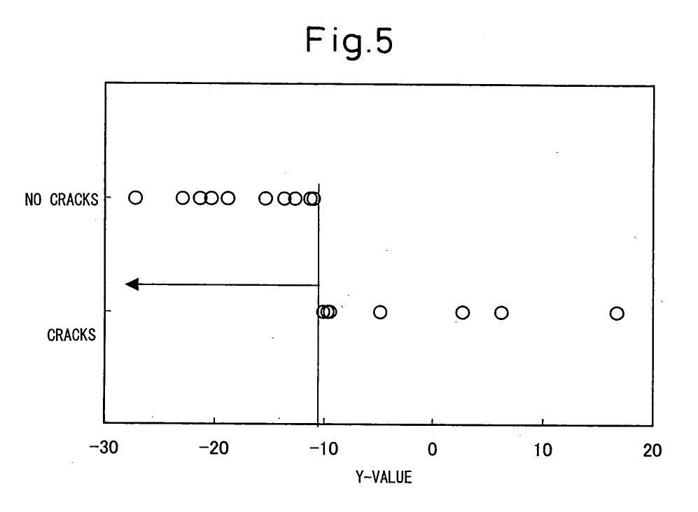

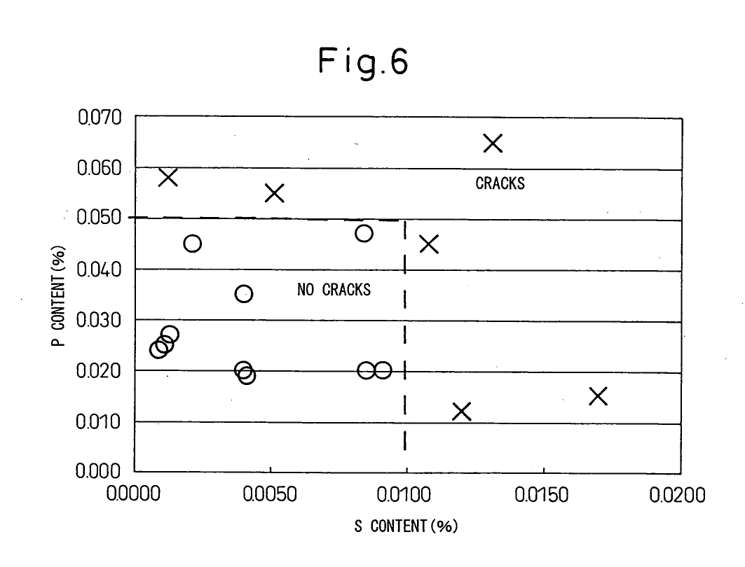

In the present invention, the sacrificial corrosion-proofing function and consumption life of the inner surface of a fuel tank or fuel pipe in a salt environment and the corrosion resistance of the inner surface of a fuel tank or fuel pipe in a fuel environment were considered for selection of Sn and an Sn—Zn alloy mainly comprised of Sn and containing Zn. As shown from FIG. 1 to FIG. 4, these Sn and Sn—Zn alloy exhibit a satisfactory performance of the outer surface and inner surface of a fuel tank or fuel pipe in a corrosive environment. However, in an Sn—Zn alloy, if the Zn content exceeds 10.0%, the elution of Zn becomes remarkable and the problem of corrosion at the outer surface and inner surface of the fuel tank or fuel pipe appears, so the Zn content in an Sn—Zn alloy is limited to 10.0% or less. Further, the lower limit of the Zn content in the Sn—Zn alloy is made 0.8% by which the potential of the plating metal becomes sufficiently low and is maintained for a long period and as a result a good corrosion resistance is obtained. The suitable range is set as 0.8 to 10.0%. From the viewpoint of the corrosion resistance, the preferable range of the Zn content in the Sn—Zn alloy is 3.0 to 10.0%, more preferably 7.0 to 9.0%.

As the unavoidable impurities of Sn or the Sn—Zn alloy, the Fe, Ni, Cr, etc. dissolved in the plating bath from the plated material, that is, the steel sheet, or the preplated steel sheet, the refining impurities of the plating metals Sn and Zn, that is, Pb, Cd, Bi, Sb, Cu, Al, Mg, Ti, Si, etc., may be mentioned. The content usually is, for Fe, Pb, and Si, less than 0.10% and, for Ni, Cr, Cd, Bi, Sb, Cu, Al, Mg, Ti, and Si, less than 0.01%. This does not have any effect on the corrosion-proofing ability of the plating metal. Note that the “content” referred to here is the value in the plating layer.

These Sn-based corrosion-proofing metals are deemed to be formed at the surface of said stainless steel substrate. The weight is made 10 g/m² to 200 g/m². In the present invention, an unpainted fuel tank or fuel pipe is envisioned. In this case, so long as at least the corrosion-proof plating layer does not disappear, salt corrosion resistance is secured. The required corrosion-proof period is 15 years. The term of the composite cycle test corresponding to this is 180 days. The minimum necessary limit of the amount of deposition to preventing the layer from being used up during this period is set as 10 g/m². If the plating weight is large, the corrosion life is extended correspondingly. If over 200 g/m², the lifetime of the electrode used for the resistance welding is remarkably shortened and the productivity is inhibited. For this reason, the upper limit is set to 200 g/m². As the method for securing this weight, hot dipping is preferable.

Note that the amount of deposition of plating defined here is the amount of deposition on one surface. The measured surface is masked by seal tape. The plated sheet sample is then dipped in a 10% NaOH solution to dissolve only the plating layer at the opposite side of the measured surface, then the seal tape is peeled off and the weight measured. After this, the sample is again dipped in a 10% NaOH solution to dissolve the plating layer of the measured surface, then the weight is again measured. The amount of deposition is defined as what is found from the change in these weights.

If providing a preplating layer at said stainless steel substrate surface before the hot dipping of the corrosion-proofing metal, the adhesion of the corrosion-proof plating layer is improved, so this is more preferable. As the type of preplating metal, Ni, Co, or Cu alone or as an alloy with Fe can be used, but in the present invention, Ni or Fe—Ni is selected. As shown in FIG. 1, Ni and Fe are metals having lower corrosion potentials than stainless steel and difficult to corrode, so not only is the adhesion of the corrosion-proof plating layer improved, but also there is the advantage seen from the corrosion resistance that even after the Sn is consumed, corrosion prevention is possible by the exposure of the Ni or Fe—Ni. As the weight of the preplating, 0.01 to 2.0 g/m² or so is sufficient.

Sn-based plated stainless steel sheet satisfying this requirement is press formed or welded by seam welding, spot welding, or projection welding or soldered or given fittings and otherwise shaped into a fuel tank by ordinary shaping and assembly processes. Further, a fuel inlet pipe is formed by using a seam welded pipe, TIG welded pipe, or laser welded pipe made using an Sn-based plating steel sheet as a material, cold working it by pipe expansion, bending, etc., projection welding or soldering it or giving it fittings and otherwise shaping it by ordinary shaping and assembly processes. Further, a fuel line is formed by using a seam welded pipe, TIG welded pipe, or laser welded pipe made using an Sn-based plated steel sheet as a material, cold working it by bending etc., and otherwise shaping it by ordinary shaping and assembly processes.

The formed fuel tank or fuel pipe can be attached to the chassis without painting. However, depending on the model, sometimes the fuel tank is visible from the outside in the state mounted on the chassis, so from the viewpoint of aesthetic design, it is also possible to paint it black. Further, the welding or soldering in the process of production of a fuel tank or fuel pipe damages the plating layer, so it is also possible to partially touch it up by paint for the purpose of making the corrosion resistance of any such location more reliable. As the method of painting the fuel tank, the spray method or another known method is sufficient. As the method of painting a fuel pipe, the electrodeposition method can also be used in addition to the spray method.

When predicated on black paint, the part is preferably plated for corrosion-proofing, then formed with a chemical conversion film to improve the paint adhesion. As the chemical conversion method, trivalent chrome type chromate treatment not containing hexavalent chrome or another known technique may be used. As the weight, 2 g/m² or less not obstructing the resistance weldability is preferable.

Further, to make the workability more reliable at the time of press forming or other cold working, an organic lubrication film may be formed on the corrosion-proof plating layer or on the chemical conversion film. The lubrication film in this case preferably has a friction coefficient of 0.15 or less. The Sn-based plating surface is superior in slidability. By just coating the plated sheet with a press oil, a 0.15 or so low friction coefficient is obtained. That is, even if forming a lubrication film with a friction coefficient larger than this value, the weldability will not be improved compared with the case of coating said plated sheet with press oil, so the upper limit of the friction coefficient is defined as 0.15.

As the composition of the lubrication film, it is preferable that the resin ingredient of the lubrication film dissolve in warm water or alkali water so as to enable easy removal at the stage after press forming or other cold working and before welding or soldering. The organic lubrication film is broken down by the rise in temperature due to the welding or soldering, carburization of the heat affected zone occurs, the grain boundary corrosion sensitivity rises, and the long term corrosion resistance is liable to be degraded. Further, the decomposed products of the film resulting from the rise in temperature form fumes which cause a bad odor, so a need arises to keep the welding or soldering work environment clean. To solve this problem, it is sufficient to remove the lubrication film before the welding or soldering. It is preferable that the lubrication film can be removed by a simple means such as washing using warm water or alkali water after press forming. Such a water soluble lubrication film is comprised of a lubrication function imparting agent and a binder ingredient. As the binder ingredient, one may be selected from polyethylene glycol-based, polypropylene glycol-based, polyvinyl alcohol-based, acryl-based, polyester-based, polyurethane-based, or other resin aqueous dispersions or water soluble resins. Further, as the lubrication function imparting agent, one may be selected from a polyolefin-based wax, fluorine-based wax, paraffin-based wax, and stearic acid-based wax.

Regarding the thickness of the lubrication film, if too thin, the lubrication effect becomes insufficient, so a certain degree of thickness is required. It is preferable to manage 0.5 μm as the required lower limit thickness. Regarding the upper limit, if the film is too thick, time is taken for removal of the film, the deterioration of the alkali solution used is accelerated, and the film removal step is otherwise adversely affected, so 5 μm is preferably set as the upper limit.

The means for forming the lubrication film is not particularly prescribed, but roll coating is preferable from the viewpoint of uniform control of the film thickness.

Next, the surface treated stainless steel welded pipe for a fuel inlet pipe will be explained.

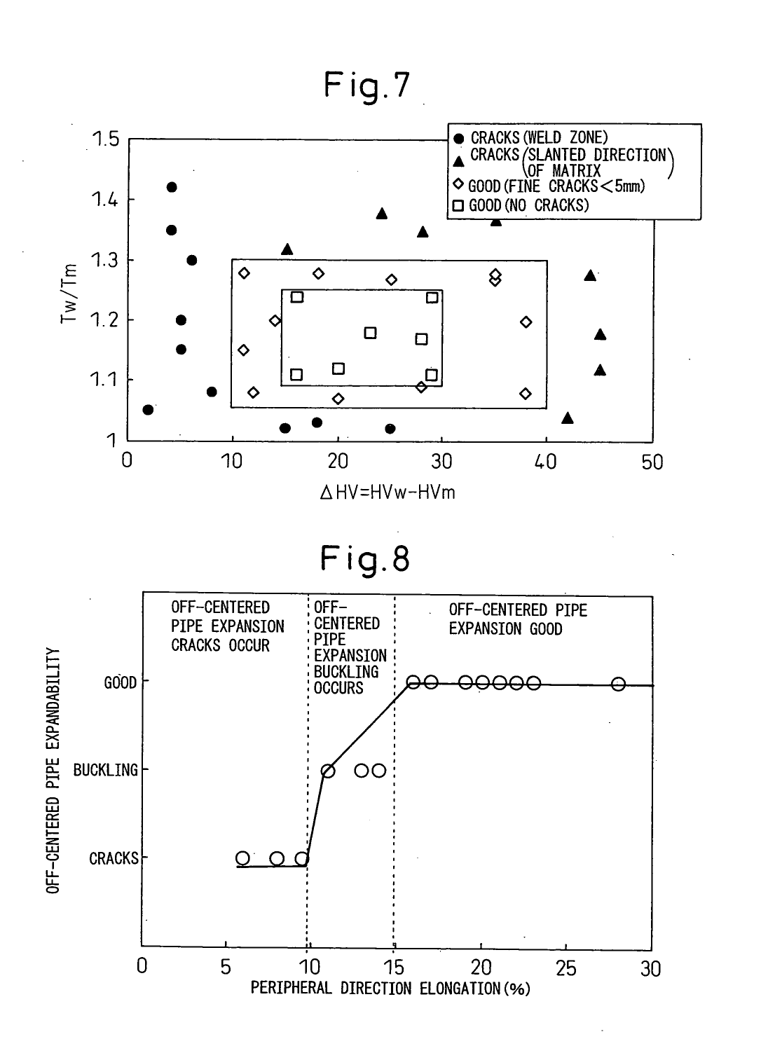

A fuel inlet pipe is usually shaped by a multi-stage process of pipe expansion using a punch. At each stage, due to the deformation resistance and frictional force of the punch, the pipe is expanded while receiving compression deformation in the pipe axial direction and tensile deformation in the pipe circumferential direction. In this working, if the balance of strength of the weld zone and matrix material part of the welded pipe is not appropriate, it will lead to cracks. That is, as shown in FIG. 7, when the hardness difference between the matrix material and weld zone is small, the weld bead is thin, or otherwise the strength of the weld zone is relatively low compared with the matrix material part, cracks occur in the axial direction of the weld zone (vertical direction). On the other hand, when the hardness difference of the matrix material and the weld zone is large, the weld bead is thick, and otherwise the strength of the weld zone is too high compared with the matrix material part, the displacement of the weld zone in the pipe axial direction becomes smaller than the matrix material part, the weld zone sticks out at the ends of the expanded pipe, the difference in the amount of displacement of the weld zone and the matrix material part in the pipe axial direction causes the shear-like deformation between the two to become larger, and cracks occur in the slanted direction from the matrix material part near the weld zone. For this reason, with a hardness difference ΔHv (=Hv_{W}−Hv_{M}) between the Vicker's hardness Hv_{W} of the weld zone and the Vicker's hardness Hv_{M} of the matrix material part of 10 to 40 in range, the ratio RT (=T_{W}/T_{M}) of the bead thickness T_{W} of the weld zone and the wall thickness T_{M} of the matrix material is defined as 1.05 to 1.3 in range. Further, when accompanied with off-centered pipe expansion, the off-centered part sticks out and locally receives tensile deformation in the pipe axial direction and circumferential direction, so as shown in FIG. 8, the lower limit of the circumferential direction elongation of the welded pipe matrix material part is defined as 15%.

As the means for obtaining pipe expandability, when the sheet is formed into an open pipe shape by roll forming or gauge forming, it is necessary to secure ductility in the circumferential direction by the method and conditions of shaping by as low a strain as possible and, for the weld zone, setting an appropriate amount of upset by the overall shaping and squeeze roll, setting an appropriate amount of straightening, providing weld bead cutting standards, and managing the balance of strength between the weld zone and matrix material part to a suitable range.

Note that for the hardness difference ΔHv of the welded pipe, the Vicker's hardness of the weld zone was measured by a micro-Vicker's hardness meter at a load of 500 g at 0.2 mm intervals, while the Vicker's hardness of the matrix material part was measured at seven points, other than the weld zone, around the entire circumference at 45° intervals by a load of 500 g. The average was taken and evaluated as the hardness difference. For the ratio of the wall thickness, the thickest part of the weld zone was deemed the weld zone wall thickness, the matrix material part was measured for Vicker's hardness at seven points, and the average was used as the matrix material wall thickness. Further, for the circumferential direction elongation of the welded pipe matrix material part, the pipe was cut in the circumferential direction and spread open, then a tensile test piece was cut out based on JIS13 No. B. Grips were welded to the two ends, then the tensile test was performed and the total elongation was determined.

Further, a fuel line will be explained.

A fuel line requires milder working compared with a fuel inlet pipe, that is, an extent of bending. Therefore, said welded pipe for a fuel inlet pipe can be applied as is for a fuel line as well.

Note that the method of making said welded pipe does not particularly have to be limited. Seam welding, laser welding, TIG welding, MIG welding, high frequency welding, or other known technology may be used.

### EXAMPLES

The present invention will be explained in further detail based on examples.

### Example 1

### Weld Crack Sensitivity

Stainless steel of each of the compositions shown in Table 1 was melted in a 150 kg vacuum melting furnace, cast into 50 kg steel ingots, then processed by the steps of hot rolling-annealing of the hot rolled plate-pickling-cold rolling-process annealing-cold rolling-final annealing-final pickling to prepare a steel sheet of a thickness of 0.8 mm.

A cut sample was taken from each steel sheet, preplated with Ni, then hot dipped in an Sn-based alloy. The plating weight was made 30 to 40 g/m² per side. From this hot dipped sample, 70×150 size rectangular samples were taken. Two were stacked and seam welded, then the cross-section of the weld zone was evaluated for cracks by observation under a microscope.

The results of evaluation are shown in Table 1. Comparative Example Nos. 21 to 27 had Y-values over the scope of the present invention, so cracks due to liquid metal embrittlement occurred at the weld heat affected zones. The cracks of No. 23 (SUS304L) and No. 24 (SUS316L) where the Ni contents were large and the Y-values high were cracks of a scale enabling clear recognition by visual observation of the appearance. Further, Comparative Example Nos. 28 to 33 had Y-values satisfying the scope of the present invention, but had one or both of the P content and S content outside the scope of the present invention, so cracks were observed. On the other hand, the Invention Example Nos. 1 to 10 had suitable Y-values and failed to show any cracks even when observed under a microscope.

TABLE 1

| | | | | | | | | | | | | | | | | | Y- | |
|---|---|---|---|---|---|---|---|---|---|---|---|---|---|---|---|---|---|---|
| No. | Class | C | Si | Mn | P | S | Cu | Ni | Cr | Mo | Al | Ti | Nb | V | N | B | value | Cracks |
| 1 | Inv. ex. | 0.0049 | 0.45 | 0.35 | 0.019 | 0.0041 | 0.01 | 0.01 | 10.92 | 0.01 | 0.052 | 0.181 | 0.00 | 0.00 | 0.0081 | 0.0000 | −12.7 | No |
| 2 | Inv. ex. | 0.0050 | 0.09 | 0.05 | 0.020 | 0.0040 | 0.01 | 0.01 | 10.08 | 0.01 | 0.052 | 0.182 | 0.00 | 0.01 | 0.0085 | 0.0005 | −11.0 | No |
| 3 | Inv. ex. | 0.0050 | 0.08 | 0.05 | 0.047 | 0.0084 | 0.01 | 0.01 | 12.55 | 0.01 | 0.052 | 0.181 | 0.00 | 0.01 | 0.0083 | 0.0005 | −13.7 | No |
| 4 | Inv. ex. | 0.0050 | 0.11 | 0.05 | 0.045 | 0.0021 | 0.01 | 0.01 | 14.01 | 0.01 | 0.052 | 0.182 | 0.00 | 0.01 | 0.0083 | 0.0005 | −15.4 | No |
| 5 | Inv. ex. | 0.0050 | 0.15 | 0.05 | 0.020 | 0.0091 | 0.01 | 0.01 | 17.01 | 0.01 | 0.052 | 0.181 | 0.00 | 0.02 | 0.0082 | 0.0005 | −18.8 | No |
| 6 | Inv. ex. | 0.0050 | 0.25 | 0.05 | 0.035 | 0.0040 | 0.01 | 0.01 | 19.02 | 0.01 | 0.052 | 0.181 | 0.00 | 0.02 | 0.0082 | 0.0005 | −21.3 | No |
| 7 | Inv. ex. | 0.0050 | 0.22 | 0.05 | 0.020 | 0.0085 | 0.01 | 0.01 | 24.51 | 0.01 | 0.052 | 0.182 | 0.00 | 0.02 | 0.0081 | 0.0004 | −27.2 | No |
| 8 | Inv. ex. | 0.0051 | 0.19 | 0.11 | 0.025 | 0.0011 | 0.03 | 0.01 | 17.16 | 1.19 | 0.055 | 0.191 | 0.00 | 0.01 | 0.0098 | 0.0000 | −20.3 | No |
| 9 | Inv. ex. | 0.0051 | 0.07 | 0.11 | 0.024 | 0.0009 | 0.03 | 2.90 | 17.16 | 1.17 | 0.055 | 0.199 | 0.01 | 0.01 | 0.0101 | 0.0000 | −11.3 | No |
| 10 | Inv. ex. | 0.0043 | 0.06 | 0.13 | 0.027 | 0.0013 | 0.03 | 0.01 | 19.01 | 1.97 | 0.055 | 0.248 | 0.27 | 0.01 | 0.0149 | 0.0000 | −22.9 | No |
| 21 | Comp. | 0.0191 | 0.51 | 0.51 | 0.025 | 0.0011 | 0.19 | 1.05 | 11.51 | 0.01 | 0.015 | 0.240 | 0.00 | 0.00 | 0.0134 | 0.0000 | −9.7 | Yes |
| | ex. | | | | | | | | | | | | | | | | | |
| 22 | Comp. | 0.0095 | 0.05 | 0.59 | 0.025 | 0.0011 | 0.04 | 0.04 | 10.08 | 0.01 | 0.015 | 0.106 | 0.00 | 0.00 | 0.0148 | 0.0000 | −10.1 | Yes |
| | ex. | | | | | | | | | | | | | | | | | |
| 23 | Comp. | 0.0215 | 0.38 | 0.87 | 0.016 | 0.0012 | 0.01 | 8.37 | 17.98 | 0.11 | 0.025 | 0.002 | 0.00 | 0.00 | 0.0298 | 0.0000 | 6.2 | Yes |
| | ex. | | | | | | | | | | | | | | | | | |
| 24 | Comp. | 0.0215 | 0.44 | 0.87 | 0.016 | 0.0012 | 0.26 | 12.17 | 17.98 | 2.22 | 0.025 | 0.001 | 0.00 | 0.00 | 0.0801 | 0.0000 | 16.7 | Yes |
| | ex. | | | | | | | | | | | | | | | | | |
| 25 | Comp. | 0.0190 | 1.51 | 0.87 | 0.016 | 0.0012 | 2.30 | 8.01 | 18.03 | 0.11 | 0.025 | 0.081 | 0.00 | 0.00 | 0.0298 | 0.0000 | 2.7 | Yes |
| | ex. | | | | | | | | | | | | | | | | | |
| 26 | Comp. | 0.0215 | 1.71 | 1.5 | 0.025 | 0.0012 | 0.01 | 4.70 | 18.21 | 2.72 | 0.025 | 0.001 | 0.00 | 0.00 | 0.0840 | 0.0000 | −9.5 | Yes |
| | ex. | | | | | | | | | | | | | | | | | |
| 27 | Comp. | 0.0051 | 0.05 | 0.11 | 0.024 | 0.0009 | 0.03 | 5.01 | 17.16 | 1.17 | 0.055 | 0.199 | 0.01 | 0.01 | 0.0101 | 0.0000 | −4.9 | Yes |
| | ex. | | | | | | | | | | | | | | | | | |
| 28 | Comp. | 0.0121 | 0.03 | 0.18 | 0.015 | 0.0170 | 0.01 | 0.01 | 13.11 | 0.01 | 0.05 | 0.000 | 0.00 | 0.00 | 0.0078 | 0.0000 | −13.8 | Yes |
| | ex. | | | | | | | | | | | | | | | | | |
| 29 | Comp. | 0.0121 | 0.04 | 0.18 | 0.045 | 0.0108 | 0.01 | 0.01 | 15.78 | 0.01 | 0.05 | 0.080 | 0.00 | 0.05 | 0.0081 | 0.0000 | −16.8 | Yes |
| | ex. | | | | | | | | | | | | | | | | | |
| 30 | Comp. | 0.0030 | 0.05 | 0.18 | 0.012 | 0.0120 | 0.01 | 0.01 | 18.45 | 0.01 | 0.04 | 0.120 | 0.00 | 0.00 | 0.0085 | 0.0000 | −20.1 | Yes |
| | ex. | | | | | | | | | | | | | | | | | |
| 31 | Comp. | 0.0111 | 0.03 | 0.18 | 0.055 | 0.0051 | 0.01 | 0.01 | 13.12 | 0.01 | 0.05 | 0.000 | 0.00 | 0.00 | 0.0081 | 0.0000 | −13.8 | Yes |
| | ex. | | | | | | | | | | | | | | | | | |
| 32 | Comp. | 0.0050 | 0.05 | 0.18 | 0.065 | 0.0131 | 0.01 | 0.01 | 15.81 | 0.01 | 0.05 | 0.080 | 0.00 | 0.06 | 0.0082 | 0.0000 | −17.1 | Yes |
| | ex. | | | | | | | | | | | | | | | | | |
| 33 | Comp. | 0.0030 | 0.05 | 0.18 | 0.058 | 0.0012 | 0.01 | 0.01 | 18.46 | 0.01 | 0.04 | 0.120 | 0.00 | 0.00 | 0.0079 | 0.0000 | −20.1 | Yes |
| | ex. | | | | | | | | | | | | | | | | | |

Y = 3.0Ni + 30C + 30N + 0.5Mn + 0.3Cu − 1.1Cr − 2.6Si − 1.1Mo − 0.6(Nb + Ti) − 0.3(Al + V)
Underlined parts: Outside scope of present invention.

### Example 2

### Pressability

Slabs of ferrite-based stainless steels A, B, C, and E and 9% Cr steel D of the compositions shown in Table 2 were processed by the steps of hot rolling-pickling-first cold rolling-process annealing-second cold rolling-final annealing-final pickling to produce 0.8 mm thick steel sheets. The cold rolling reduction rate was made a cumulative 73 to 75%, the process annealing was performed at 850° C. or 900° C., and the final annealing was performed at 830 to 950° C. The material properties were changed by the presence/absence of process annealing and the second cold rolling. Each steel sheet was electroplated by Ni preplating of a weight of 1.0 g/m², then was formed with an Sn-based corrosion-proof plating layer of the composition shown in Table 3 by the hot dipping method. At the time of hot dipping, the gas wiping was changed to change the weight. A tensile test piece was obtained from each steel sheet and subjected to a tensile test to obtain a grasp of the material properties shown in Table 3.

From each steel sheet, a φ100 mm sample was punched and masked at the measured surface by seal tape, then the plated sheet sample was dipped in a 10% NaOH solution to dissolve only the plating layer at the opposite side of the measured surface. The seal tape was peeled off, the sample sheet was again punched to φ70 mm, the sample sheet was measured for weight, then was dipped in a 10% NaOH solution to dissolve the plating layer of the measured surface, the weight was again measured, then the amount of deposition of plating of one side was found from the change in weights.

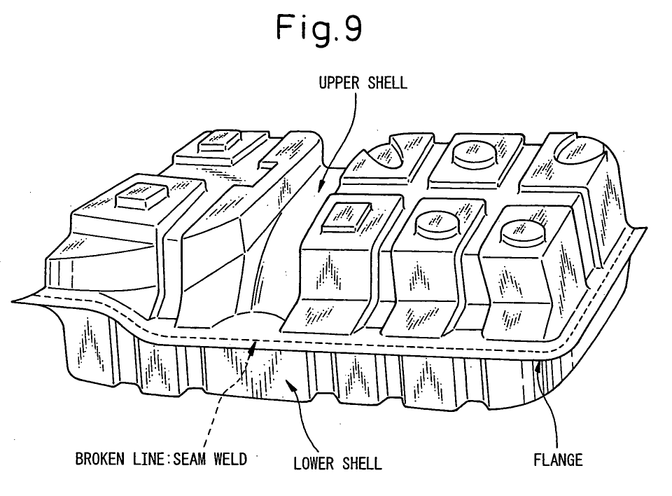

Each thus produced plated steel sheet was used for a press test. The shape of the tank formed is shown in FIG. 9. The upper and lower shells were formed with recesses for raising the rigidity of the tank, recesses at locations for attaching the tank suspension bands, and projections at parts for contacting the chassis at all different locations. The shaped height was made about 150 mm for both shells. The upper side shell was more complicated in shape than the lower side and more difficult in working conditions. In almost all tests, the steel sheet as plated by Sn-based plating was coated by press oil and pressed in that state, but in some tests, a water soluble type lubrication film was formed, then the sheet was provided for the test. The method of formation of the lubrication film is as explained below.

A four-neck flask equipped with an agitator, dimroth cooler, nitrogen introduction tube, silica gel drying tube, and thermometer was charged with 3-isocyanate methyl-3,5,5-trimethylcyclohexyl isocyanate 87.11 g, 1,3-bis(1-isocyanate-1-methylethyl)benzene 31.88 g, dimethylol propionic acid 41.66 g, triethylene glycol 4.67 g, a molecular weight 2000 polyester polyol comprised of adipic acid, neopentyl glycol, and 1,6-hexane diol 62.17 g, and acetonitrile 122.50 g as a solvent, and the result was raised in temperature under a nitrogen atmosphere to 70° C. and agitated for 4 hours to obtain an acetonitrile solution of a polyurethane prepolymer. This polyurethane prepolymer solution 346.71 g was dispersed in an aqueous solution of sodium hydroxide 12.32 g dissolved in 639.12 g of water using a homodisperser and emulsified. To this was added a solution of 2-[(2-aminoethyl)amino]ethanol 12.32 g diluted by water 110.88 g to cause a chain extension reaction, then the result was treated at 50° C. under a reduced pressure of 150 mmHg to distill off the acetonitrile used at the time of synthesis of the polyurethane prepolymer to thereby obtain a substantially solvent-free acid value 69, solid concentration 25%, viscosity 30 mPa·s polyurethane aqueous composition. To this polyurethane aqueous composition, one or two of a softening point 110° C., average particle size 2.5 μm low density polyethylene wax, average particle size 3.5 μm polytetrafluoroethylene wax, melting point 105° C., average particle size 3.5 μm synthetic paraffin wax, average particle size 5.0 μm calcium stearate wax, and primary average particle size 20 nm, heat residue 20% colloidal silica to prepare a paint. The ratio of blending of the wax ingredients in the polyurethane aqueous composition was changed to change the friction coefficient of the lubrication film formed. This paint was coated on said Sn-based corrosion-proofing plated steel sheet by the roll coat method and was baked by a sheet temperature of 80° C. to form a dissolvable lubrication film. The thickness was made 1.0 μm. Note that in part of the test materials, said plated steel sheet was treated by chromate. The weight was made 20 mg/m².

The presence of any substrate cracking and plating peeling was evaluated in the upper and low pressed parts after this press forming test.

The test results are shown in Table 3. Comparative Example Nos. 202 to 205 had either an r-value or total elongation outside the scope of the present invention, so press forming resulted in cracks or plating peeling. On the other hand, the Invention Example Nos. 101 to 116 had suitable r-values and total elongations of course and also friction coefficients of the lubrication films, so press forming was possible without cracks.

TABLE 2

| | | | | | | | | | | | | | | | | | | (Ti + |
|---|---|---|---|---|---|---|---|---|---|---|---|---|---|---|---|---|---|---|
| | | | | | | | | | | | | | | | | | | Nb)/ |
| Sym- | | | | | | | | | | | | | | | | | Y- | (C + |
| bol | Class | C | Si | Mn | P | S | Cu | Ni | Cr | Mo | Al | Ti | Nb | V | N | B | value | N) |
| A | Y432 | 0.0070 | 0.09 | 0.10 | 0.023 | 0.0014 | 0.03 | 0.11 | 17.28 | 0.47 | 0.064 | 0.252 | 0.000 | 0.058 | 0.0131 | 0.0000 | −19.0 | 12.5 |
| B | 409L | 0.0069 | 0.11 | 0.23 | 0.028 | 0.0060 | 0.01 | 0.07 | 10.31 | 0.01 | 0.010 | 0.187 | 0.002 | 0.042 | 0.0079 | 0.0005 | −11.0 | 12.8 |
| C | AISI439 | 0.0035 | 0.41 | 0.11 | 0.024 | 0.0008 | 0.03 | 0.11 | 17.36 | 0.02 | 0.070 | 0.288 | 0.001 | 0.044 | 0.0088 | 0.0000 | −19.6 | 23.5 |
| D | 9CR | 0.0023 | 0.25 | 0.01 | 0.021 | 0.0005 | 0.01 | 0.01 | 9.15 | 0.01 | 0.019 | 0.215 | 0.002 | 0.021 | 0.0098 | 0.0000 | −10.5 | 17.9 |
| E | SUS430 | 0.0754 | 0.28 | 0.61 | 0.021 | 0.0005 | 0.01 | 0.09 | 16.14 | 0.03 | 0.081 | 0.006 | 0.001 | 0.049 | 0.0239 | 0.0000 | −15.0 | 0.1 |

Underlined parts: Outside scope of present invention.
Y = 3.0Ni + 30C + 30N + 0.5Mn + 0.3Cu − 1.1Cr − 2.6Si − 1.1Mo − 0.6(Nb + Ti) − 0.3(Al + V)

TABLE 3

| | | | Cold | | Cold | | | | | | |
|---|---|---|---|---|---|---|---|---|---|---|---|
| | | | rolling | Process | rolling | Final | | Total | | Plating | |
| | | | reduction | annealing | reduction | annealing | Average | elongation | Plating | deposition | Chromate |
| Class | No. | Steel | rate | temp. | rate | temp. | r-value | (%) | composition | (g/m²) | treatment |
| Inv. ex. | 101 | A | 44% | 900° C. | 29% | 950° C. | 2.10 | 35.1 | Sn | 35 | Yes |
| | 102 | A | 44% | 900° C. | 29% | 950° C. | 2.10 | 35.1 | Sn | 35 | No |
| | 103 | A | 44% | 900° C. | 29% | 950° C. | 2.10 | 35.1 | Sn—1.0% Zn | 40 | Yes |
| | 104 | A | 44% | 900° C. | 29% | 950° C. | 2.03 | 34.9 | Sn—8.0% Zn | 38 | Yes |
| | 105 | A | 44% | 900° C. | 29% | 950° C. | 1.98 | 34.7 | Sn—9.9% Zn | 75 | Yes |
| | 106 | A | 44% | 900° C. | 29% | 950° C. | 2.00 | 35.0 | Sn | 8 | Yes |
| | 107 | A | 75% | No | No | 950° C. | 1.60 | 31.3 | Sn | 35 | No |
| | 108 | A | 44% | 900° C. | 29% | 950° C. | 2.10 | 35.1 | Sn | 40 | Yes |
| | 109 | B | 44% | 900° C. | 29% | 950° C. | 2.25 | 34.9 | Sn | 35 | No |
| | 110 | B | 44% | 900° C. | 29% | 950° C. | 2.25 | 34.9 | Sn—1.0% Zn | 35 | No |
| | 111 | B | 44% | 900° C. | 29% | 950° C. | 2.25 | 34.9 | Sn—8.0% Zn | 35 | No |
| | 112 | B | 44% | 900° C. | 29% | 950° C. | 2.25 | 34.9 | Sn—9.9% Zn | 35 | No |
| | 113 | C | 44% | 850° C. | 29% | 910° C. | 2.05 | 34.8 | Sn | 35 | No |
| | 114 | C | 44% | 850° C. | 29% | 910° C. | 2.05 | 34.8 | Sn—1.0% Zn | 35 | No |
| | 115 | C | 44% | 850° C. | 29% | 910° C. | 2.05 | 34.8 | Sn—8.0% Zn | 35 | No |
| | 116 | C | 44% | 850° C. | 29% | 910° C. | 2.05 | 34.8 | Sn—9.9% Zn | 35 | No |
| C. ex. | 201 | A | 44% | 900° C. | 29% | 950° C. | 2.10 | 35.1 | Sn | 205 | No |
| | 202 | A | 75% | No | No | 900° C. | 1.36 | 33.1 | Sn | 35 | No |
| | 203 | A | 75% | No | No | 830° C. | 1.41 | 28.7 | Sn | 35 | No |
| | 204 | B | 75% | No | No | 850° C. | 1.38 | 33.0 | Sn | 35 | No |
| | 205 | E | 75% | No | No | 830° C. | 1.22 | 29.1 | Sn—8.0% Zn | 35 | No |

| | | Lubrication film | | | | | | | | |
|---|---|---|---|---|---|---|---|---|---|---|
| | | | | Type and content | | | | | | |
| | | | | of lubrication | | | | | | Spot |
| | | | | function | Silica | Film | | Press test | | welding |
| | | | Resin | imparting | content | thickness | Friction | results*2) | | electrode |
| Class | No. | Presence | ingredient | agent*1) | (%) | (μm) | coefficient | Lower | Upper | life |
| Inv. ex. | 101 | No | | | | | | Good | Good | Good |
| | 102 | No | | | | | | Good | Good | Good |
| | 103 | No | | | | | | Good | Good | Good |
| | 104 | No | | | | | | Good | Good | Good |
| | 105 | No | | | | | | Good | Good | Good |
| | 106 | Yes | Soluble | PTFE | — | 1.1 | 0.039 | Good | Good | Good |
| | | | poly- | wax 20% | | | | | | |
| | | | urethane | | | | | | | |
| | 107 | Yes | Soluble | Paraffin | — | 1.1 | 0.075 | Good | Good | Good |
| | | | poly- | wax 10% | | | | | | |
| | | | urethane | | | | | | | |
| | 108 | Yes | Soluble | Potassium | — | 1.2 | 0.054 | Good | Good | Good |
| | | | poly- | stearate wax 10% | | | | | | |
| | | | urethane | | | | | | | |
| | 109 | Yes | Soluble | PE | 10 | 1.2 | 0.111 | Good | Good | Good |
| | | | poly- | wax 10% | | | | | | |
| | | | urethane | | | | | | | |
| | 110 | No | | | | | | Good | Good | Good |
| | 111 | No | | | | | | Good | Good | Good |
| | 112 | No | | | | | | Good | Good | Good |
| | 113 | No | | | | | | Good | Good | Good |
| | 114 | No | | | | | | Good | Good | Good |
| | 115 | No | | | | | | Good | Good | Good |
| | 116 | No | | | | | | Good | Good | Good |
| C. ex. | 201 | No | | | | | | Good | Good | Poor |
| | 202 | No | | | | | | Poor | Poor | Good |
| | 203 | No | | | | | | Good | Poor | Good |
| | 204 | No | | | | | | Poor | Poor | Good |
| | 205 | No | | | | | | Poor | Poor | Good |

Underlined parts: Outside scope of present invention.
*1)PEwax: Low density polyethylene wax. PTFEwax: Polytetrafluoroethylene wax.
*2)Good: No substrate cracks, no plating peeling. Poor: Substrate cracks or plating peeling.
Content: Ratio with respect to resin solid content.

### Example 3

### Spot Welding Electrode Life

The Sn-based corrosion-proof plating steel sheet produced in Example 2 was continuously spot welded. The number of continuous welded points until the electrode was used up and welding was no longer possible was found. The case of a drop in the lifetime to less than ½ of the lifetime in the case of no corrosion-proof plating was evaluated as “failing”.

Details of the test materials and the test results are shown in Table 3. Comparative Example No. 201 had a corrosion-proof plating weight too large over the scope of the present invention, so the contact area of the electrode and corrosion-proof plating increased and the electrode consumption life became shorter. On the other hand, the invention Example Nos. 101 to 116 and Comparative Example Nos. 202 to 205 had suitable plating weights, so remarkable electrode loss was avoided.

### Example 4

### Salt Corrosion Resistance of Weld Zone and Welding Crevice Structures

The Sn-based corrosion-proof plating steel sheet produced in Example 2 was used to obtain rectangular samples of 70×150 size. Two of these were stacked and seam welded for use for a salt corrosion test. As the content of the corrosion test, spraying of a 5% NaCl solution at 35° C.×2 Hr→forced drying (relative humidity 20%) at 60° C.×4 Hr→and moistening (relative humidity 90%) at 50° C.×2 Hr in a composite cycle test was repeated for 540 cycles, then the rust was removed from the seam weld heat affected zone and the corrosion depth was measured. The seam welded crevice structure was disassembled, the rust was removed, and the corrosion depth inside the crevice was measured. The corrosion depth was found by the microscope focal point depth method. Further, the form of corrosion at the weld zone cross-section was observed under a microscope to evaluate the presence of any grain boundary corrosion.

Note that for some of the samples, the plating steel sheet was treated by chromate. The weight was made 20 mg/m². Further, for part of the samples, the samples after seam welding were sprayed with black paint. As the paint, Emalta 5600 made by Aisin Chemical was used. The film thickness was made 25 μm.

Details of the test materials and the test results are shown in Table 4. Comparative Example No. 205 had a Ti content not satisfying the requirements of the present invention, so grain boundary corrosion at the weld zone was observed, and the resistance to local corrosion was also insufficient. Further, Comparative Example No. 304 had a Cr content outside the scope of the present invention, so a sufficient corrosion resistance could not be obtained. Comparative Example Nos. 301, 302, and 303 had steel ingredients satisfying the requirements of the present invention, but had weights of the corrosion-proof platings outside the scope of the present invention, so satisfactory corrosion resistances could not be obtained. Comparative Example No. 305 had a composition of the corrosion-proof plating and weight outside the scope of the present invention, so a satisfactory corrosion resistance could not be obtained. On the other hand, the Invention Example Nos. 101 to 116 had both steel ingredients and plating weights satisfying the requirements of the present invention. Regardless of any chromate treatment and black painting, satisfactory corrosion resistances were obtained.

TABLE 4

| | | | | | | | Salt corrosion | |
|---|---|---|---|---|---|---|---|---|
| | | | | | | | resistance | |
| | | | | | | | Local | |
| | | | | | | | corrosion of | |
| | | | | | | | weld heat | Grain |
| | | | | | | | affected | boundary |
| | | | | Plating | | | zone or | corrosion |
| | | | Plating | weight | Chromate | Black | inside of | of weld |
| Class | No. | Steel | composition | (g/m²) | treatment | paint | crevices *3) | zone |
| Inv. ex. | 101 | A | Sn | 35 | Yes | No | Good | No |
| | 102 | A | Sn | 35 | No | No | Good | No |
| | 103 | A | Sn—1.0% Zn | 40 | Yes | Yes | Good | No |
| | 104 | A | Sn—8.0% Zn | 38 | Yes | Yes | Good | No |
| | 105 | A | Sn—9.9% Zn | 75 | Yes | No | Good | No |
| | 106 | A | Sn | 8 | Yes | No | Good | No |
| | 107 | A | Sn | 35 | No | No | Good | No |
| | 108 | A | Sn | 40 | Yes | No | Good | No |
| | 109 | B | Sn | 35 | No | No | Good | No |
| | 110 | B | Sn—1.0% Zn | 35 | Yes | Yes | Good | No |
| | 111 | B | Sn—8.0% Zn | 35 | No | No | Good | No |
| | 112 | B | Sn—9.9% Zn | 35 | Yes | No | Good | No |
| | 113 | C | Sn | 35 | No | No | Good | No |
| | 114 | C | Sn—1.0% Zn | 35 | No | No | Good | No |
| | 115 | C | Sn—8.0% Zn | 35 | No | No | Good | No |
| | 116 | C | Sn—9.9% Zn | 35 | No | No | Good | No |
| Co. ex. | 205 | E | Sn—8.0% Zn | 35 | Yes | No | Poor | Yes |
| | 301 | A | Sn | 8 | No | No | Poor | No |
| | 302 | B | Sn | 8 | No | No | Poor | No |
| | 303 | C | Sn—8.0% Zn | 8 | No | No | Poor | No |
| | 304 | D | Sn—8.0% Zn | 35 | Yes | No | Poor | No |
| | 305 | C | Sn—14.8% Zn | 35 | No | No | Poor | No |

Underlined parts: Outside scope of present invention.
*3) Good: Ratio of maximum corrosion depth to original thickness of 50% or less Poor: Ratio of maximum corrosion depth to original thickness of over 50%

### Example 5

### Inner Surface Corrosion Resistance

The Sn-based corrosion-proof plating steel sheet produced in Example 2 was used to obtain 170×170 size samples, an Erickson tester was used to shape them into cups of inside diameters of 75 mm and heights of 45 mm, the insides were filled with a corrosive liquid, and the cups were held for 1000 Hr at 50° C. for inner surface corrosion tests. As the corrosive liquid, a 50° C. aqueous solution containing 0.01% formic acid and 0.01% acetic acid and 0.01% NaCl simulating a degraded gasoline environment and a 60° C. ethanol solution containing 3% water simulating an alcohol fuel environment were used. After the end of the test, the corrosive liquid was recovered, the amounts of metals in the liquid were quantified by chemical analysis, and the analysis values were converted to corrosion rates. The corrosion resistance was evaluated as the ratio with respect to the corrosion rate of the terne metal (Pb—Zn alloy) alone. A case of a corrosion rate more than 1 time the terne metal was evaluated as “failing”. Note that part of the tested materials were treated by chromate. The weight was made 20 mg/m².

The test results are shown in Table 5. Comparative Example Nos. 306 to 310 had corrosion-proof plating compositions outside the scope of the present invention and large Zn contents, so the amounts of elution of Zn were large and the inner surface corrosion resistances were insufficient. Further, Comparative Example No. 311 had an amount of Cr of the material of 9%, so was baser in potential compared with Sn, could not obtain the sacrificial corrosion effect by the Sn plating, and suffered from elution of iron, which was a critical defect. On the other hand, the Invention Example Nos. 101 to 116 had steel ingredients, plating compositions, and weights satisfying the requirements of the present invention. Regardless of any chromate treatment and black paint, satisfactory corrosion resistance was obtained.

TABLE 5

| | | | | | | Inner surface corrosion | |
|---|---|---|---|---|---|---|---|
| | | | | | | resistance*4) | |
| | | | | Plating | | Degraded | |
| | | | Plating | weight | Chromate | gasoline | Ethanol |
| Class | No. | Steel | composition | (g/m²) | treatment | environment | environment |
| Inv. ex. | 101 | A | Sn | 35 | Yes | Good | Good |
| | 102 | A | Sn | 35 | No | Good | Good |
| | 103 | A | Sn—1.0% Zn | 40 | Yes | Good | Good |
| | 104 | A | Sn—8.0% Zn | 38 | Yes | Good | Good |
| | 105 | A | Sn—9.9% Zn | 75 | Yes | Good | Good |
| | 106 | A | Sn | 8 | Yes | Good | Good |
| | 107 | A | Sn | 35 | No | Good | Good |
| | 108 | A | Sn | 40 | Yes | Good | Good |
| | 109 | B | Sn | 35 | No | Good | Good |
| | 110 | B | Sn—1.0% Zn | 35 | Yes | Good | Good |
| | 111 | B | Sn—8.0% Zn | 35 | No | Good | Good |
| | 112 | B | Sn—9.9% Zn | 35 | Yes | Good | Good |
| | 113 | C | Sn | 35 | No | Good | Good |
| | 114 | C | Sn—1.0% Zn | 35 | No | Good | Good |
| | 115 | C | Sn—8.0% Zn | 35 | No | Good | Good |
| | 116 | C | Sn—9.9% Zn | 35 | No | Good | Good |
| Co. ex. | 306 | A | Sn—14.8% Zn | 35 | No | Poor | Good |
| | 307 | B | Sn—11.5% Zn | 35 | Yes | Poor | Good |
| | 308 | B | Sn—20.0% Zn | 35 | No | Poor | Good |
| | 309 | B | Sn—50.0% Zn | 35 | Yes | Poor | Poor |
| | 310 | C | Sn—14.8% Zn | 35 | No | Poor | Good |
| | 311 | E | Sn | 15 | Yes | Poor | Good |

Underlined parts: Outside scope of present invention.
*4)Good: Ratio with respect to amount of corrosion of terne metal of 1 or less Poor: Ratio with respect to amount of corrosion of terne metal of 1 or more

### Example 6

### Pipe Expandability

Part of the Sn-based corrosion-proof plating steel sheet produced in Example 2 was used as a material to produce a φ25.4 mm seam welded pipe. A lubrication oil with a dynamic viscosity of about 100 mm²/s (40° C.) was used and a punch of a taper angle of 20° was used for coaxial pipe expansion to outside diameters of 30φ, 38φ, 45φ, and 51φ and off-centered pipe expansion of an offset amount of 6 mm to 51φ, that is, five steps, for multi-stage pipe expansion. The presence of any cracks or the presence of any plating peeling in the matrix material at the worked parts and around the weld zones was evaluated.

The test results are shown in Table 6. Comparative Example Nos. 202 to 212 had at least one of an revalue or total elongation of the material steel sheet, a circumferential direction elongation of the welded pipe, a hardness difference ΔHv of the Vicker's hardness Hv_{W} of the weld zone and the Vicker's hardness Hv_{M} of the matrix material, and a ratio of the bead thickness T_{W} of the weld zone and the wall thickness T_{M} of the matrix material outside the scope of the present invention, so pipe expansion resulted in cracking or plating peeling. On the other hand, in the Invention Example Nos. 101 to 105 and 111 to 116, the r-value and total elongation of the material steel sheet, the circumferential direction elongation of the welded pipe, the hardness difference ΔHv of the Vicker's hardness Hv_{W} of the weld zone and the Vicker's hardness Hv_{M} of the matrix material, and the ratio of the bead thickness T_{W} of the weld zone and the wall thickness T_{M} of the matrix material were all suitable, so no cracks occurred and working was possible. Further, since deformation did not locally concentrate, plating peeling also did not occur.

TABLE 6

| | | | | | | Hardness | | | | | |
|---|---|---|---|---|---|---|---|---|---|---|---|
| | | | | | Welded pipe | difference ΔHv | Thickness ratio | | | | Pipe |
| | | | | Material | circumferential | of weld zone | T_{W}/T_{M} of weld | | Plating | | expansion |
| | | | Average | elongation | direction | and matrix | bead and matrix | Plating | deposition | Chromate | test |
| Class | No. | Steel | r-value | (%) | elongation (%) | material | material | composition | (g/m2) | treatment | result*) |
| Inv. ex. | 101 | A | 2.10 | 35.1 | 18.4 | 21 | 1.08 | Sn | 35 | Yes | Good |
| | 102 | A | 2.10 | 35.1 | 15.8 | 18 | 1.27 | Sn | 35 | No | Good |
| | 103 | A | 2.10 | 35.1 | 20.8 | 24 | 1.21 | Sn—1.0% Zn | 40 | Yes | Good |
| | 104 | A | 2.03 | 34.9 | 18.5 | 18 | 1.15 | Sn—8.0% Zn | 38 | Yes | Good |
| | 105 | A | 1.98 | 34.7 | 20.5 | 20 | 1.18 | Sn—9.9% Zn | 75 | Yes | Good |
| | 110 | B | 2.25 | 34.9 | 24.2 | 15 | 1.23 | Sn—1.0% Zn | 35 | No | Good |
| | 111 | B | 2.25 | 34.9 | 22.5 | 14 | 1.25 | Sn—8.0% Zn | 35 | No | Good |
| | 112 | B | 2.25 | 34.9 | 20.7 | 25 | 1.19 | Sn—9.9% Zn | 35 | No | Good |
| | 113 | C | 2.05 | 34.8 | 19.9 | 30 | 1.07 | Sn | 35 | No | Good |
| | 114 | C | 2.05 | 34.8 | 20.5 | 23 | 1.18 | Sn—1.0% Zn | 35 | No | Good |
| | 115 | C | 2.05 | 34.8 | 17.5 | 22 | 1.24 | Sn—8.0% Zn | 35 | No | Good |
| | 116 | C | 2.05 | 34.8 | 19.5 | 25 | 1.16 | Sn—9.9% Zn | 35 | No | Good |
| Comp. | 202 | A | 1.36 | 33.1 | 20.4 | 20 | 1.15 | Sn | 35 | No | Poor |
| ex. | 203 | A | 1.41 | 28.7 | 16.7 | 25 | 1.17 | Sn | 35 | No | Poor |
| | 204 | A | 2.10 | 35.1 | 13.0 | 23 | 1.21 | Sn | 35 | Yes | Poor |
| | 205 | A | 2.03 | 34.9 | 17.0 | 42 | 1.15 | Sn—8.0% Zn | 38 | Yes | Poor |
| | 206 | A | 2.10 | 35.1 | 21.5 | 8 | 1.18 | Sn | 38 | Yes | Poor |
| | 207 | A | 2.03 | 34.9 | 18.5 | 25 | 1.02 | Sn—8.0% Zn | 38 | Yes | Poor |
| | 208 | A | 2.03 | 34.9 | 19.8 | 19 | 1.34 | Sn—8.0% Zn | 38 | Yes | Poor |
| | 209 | B | 1.38 | 33.0 | 20.8 | 21 | 1.15 | Sn | 35 | No | Poor |
| | 210 | B | 2.25 | 34.9 | 18.7 | 45 | 1.18 | Sn—8.0% Zn | 35 | No | Poor |
| | 211 | B | 2.25 | 34.9 | 22.5 | 19 | 1.03 | Sn—8.0% Zn | 35 | No | Poor |
| | 212 | E | 1.22 | 29.1 | 15.8 | 22 | 1.14 | Sn—8.0% Zn | 35 | No | Poor |

Underlined parts: Outside scope of present invention.
*)Good: No substrate cracks, no plating peeling Poor: Substrate cracks or plating peeling

### Example 7

### Crack Sensitivity Due to Soldering

A 70×150 size rectangular sample was taken from each hot dipped steel sheet prepared in Example 1. At the center of this, silver solder was applied over a width of 3 to 8 mm and a length of 100 mm, then the cross-section of the soldered part was observed under a microscope to evaluate it for any cracks. As the solder material, silver solder of Ag: 40.4% corresponding to JIS Z3261 B Ag4 was used.

The test results are shown in Table 7. Comparative Example Nos. 23, 24, and 27 had Y-values exceeding the scope of the present invention, so cracks due to liquid metal embrittlement occurred in the heat affected zones. Further, Comparative Example Nos. 30 to 32 had Y-values satisfying the scope of the present invention, but had one or both of the P content and S content outside the scope of the present invention, so cracks were observed. On the other hand, in the Invention Example Nos. 1 to 10, the Y-values were made suitable, so cracks could not be observed.

TABLE 7

| | | | | | | | | | | | | | | | | | Y- | |
|---|---|---|---|---|---|---|---|---|---|---|---|---|---|---|---|---|---|---|
| No. | Class | C | Si | Mn | P | S | Cu | Ni | Cr | Mo | Al | Ti | Nb | V | N | B | value | Cracks |
| 1 | Inv. ex. | 0.0049 | 0.45 | 0.35 | 0.019 | 0.0041 | 0.01 | 0.01 | 10.92 | 0.01 | 0.052 | 0.181 | 0.00 | 0.00 | 0.0081 | 0.0000 | −12.7 | No |
| 2 | Inv. ex. | 0.0050 | 0.09 | 0.05 | 0.020 | 0.0040 | 0.01 | 0.01 | 10.08 | 0.01 | 0.052 | 0.182 | 0.00 | 0.01 | 0.0085 | 0.0005 | −11.0 | No |
| 3 | Inv. ex. | 0.0050 | 0.08 | 0.05 | 0.047 | 0.0084 | 0.01 | 0.01 | 12.55 | 0.01 | 0.052 | 0.181 | 0.00 | 0.01 | 0.0083 | 0.0005 | −13.7 | No |
| 4 | Inv. ex. | 0.0050 | 0.11 | 0.05 | 0.045 | 0.0021 | 0.01 | 0.01 | 14.01 | 0.01 | 0.052 | 0.182 | 0.00 | 0.01 | 0.0083 | 0.0005 | −15.4 | No |
| 5 | Inv. ex. | 0.0050 | 0.15 | 0.05 | 0.020 | 0.0091 | 0.01 | 0.01 | 17.01 | 0.01 | 0.052 | 0.181 | 0.00 | 0.02 | 0.0082 | 0.0005 | −18.8 | No |
| 6 | Inv. ex. | 0.0050 | 0.25 | 0.05 | 0.035 | 0.0040 | 0.01 | 0.01 | 19.02 | 0.01 | 0.052 | 0.181 | 0.00 | 0.02 | 0.0082 | 0.0005 | −21.3 | No |
| 7 | Inv. ex. | 0.0050 | 0.22 | 0.05 | 0.020 | 0.0085 | 0.01 | 0.01 | 24.51 | 0.01 | 0.052 | 0.182 | 0.00 | 0.02 | 0.0081 | 0.0004 | −27.2 | No |
| 8 | Inv. ex. | 0.0051 | 0.19 | 0.11 | 0.025 | 0.0011 | 0.03 | 0.01 | 17.16 | 1.19 | 0.055 | 0.191 | 0.00 | 0.01 | 0.0098 | 0.0000 | −20.3 | No |
| 9 | Inv. ex. | 0.0051 | 0.07 | 0.11 | 0.024 | 0.0009 | 0.03 | 2.90 | 17.16 | 1.17 | 0.055 | 0.199 | 0.01 | 0.01 | 0.0101 | 0.0000 | −11.3 | No |
| 10 | Inv. ex. | 0.0043 | 0.06 | 0.13 | 0.027 | 0.0013 | 0.03 | 0.01 | 19.01 | 1.97 | 0.055 | 0.248 | 0.27 | 0.01 | 0.0149 | 0.0000 | −22.9 | No |
| 23 | Comp. | 0.0215 | 0.38 | 0.87 | 0.016 | 0.0012 | 0.01 | 8.37 | 17.98 | 0.11 | 0.025 | 0.002 | 0.00 | 0.00 | 0.0298 | 0.0000 | 6.2 | Yes |
| | ex. | | | | | | | | | | | | | | | | | |
| 24 | Comp. | 0.0215 | 0.44 | 0.87 | 0.016 | 0.0012 | 0.26 | 12.17 | 17.98 | 2.22 | 0.025 | 0.001 | 0.00 | 0.00 | 0.0801 | 0.0000 | 16.7 | Yes |
| | ex. | | | | | | | | | | | | | | | | | |
| 27 | Comp. | 0.0051 | 0.05 | 0.11 | 0.024 | 0.0009 | 0.03 | 5.01 | 17.16 | 1.17 | 0.055 | 0.199 | 0.01 | 0.01 | 0.0101 | 0.0000 | −4.9 | Yes |
| | ex. | | | | | | | | | | | | | | | | | |
| 30 | Comp. | 0.0030 | 0.05 | 0.18 | 0.012 | 0.0120 | 0.01 | 0.01 | 18.45 | 0.01 | 0.04 | 0.120 | 0.00 | 0.00 | 0.0085 | 0.0000 | −20.1 | Yes |
| | ex. | | | | | | | | | | | | | | | | | |
| 31 | Comp. | 0.0111 | 0.03 | 0.18 | 0.055 | 0.0051 | 0.01 | 0.01 | 13.12 | 0.01 | 0.05 | 0.000 | 0.00 | 0.00 | 0.0081 | 0.0000 | −13.8 | Yes |
| | ex. | | | | | | | | | | | | | | | | | |
| 32 | Comp. | 0.0050 | 0.05 | 0.18 | 0.065 | 0.0131 | 0.01 | 0.01 | 15.81 | 0.01 | 0.05 | 0.080 | 0.00 | 0.06 | 0.0082 | 0.0000 | −17.1 | Yes |
| | ex. | | | | | | | | | | | | | | | | | |

Y = 3.0Ni + 30C + 30N + 0.5Mn + 0.3Cu − 1.1Cr − 2.6Si − 1.1Mo − 0.6(Nb + Ti) − 03(Al + v)
Underlined parts: Outside scope of present invention.

### Example 8

### Salt Corrosion Resistance of Soldered Parts and Crevices

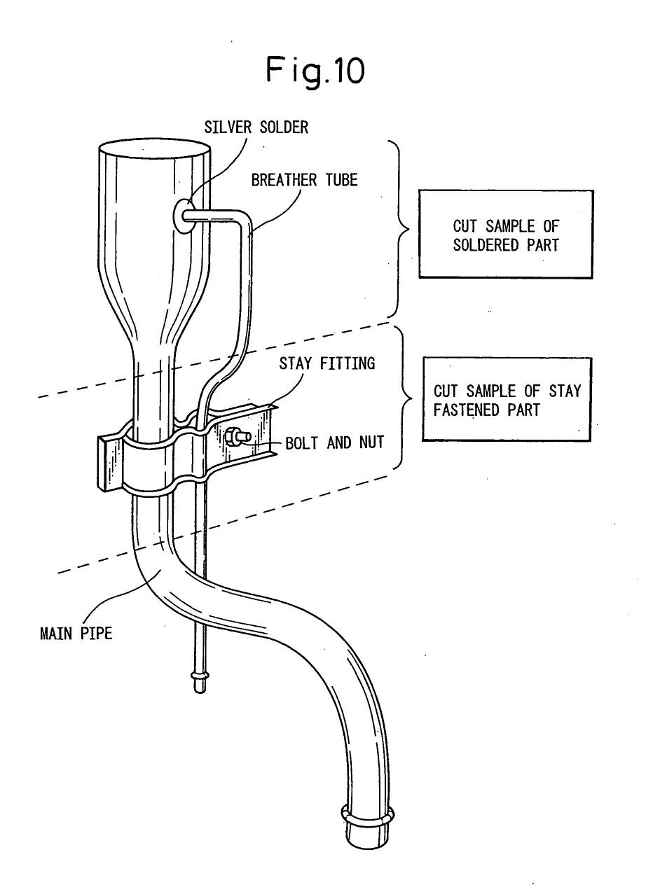

A φ25.4 mm seam welded pipe produced from each Sn-based corrosion-proof plating steel sheet produced in Example 2 was used as a material to produce a fuel pipe of the shape shown in FIG. 10. Cut samples were prepared from the soldered part and stay contact crevice part of this fuel pipe and used for a salt corrosion test. As the content of the corrosion test, spraying of a 5% NaCl solution at 35° C.×2 Hr→forced drying (relative humidity 20%) 60° C.×4 Hr→and moistening (relative humidity 90%) 50° C.×2 Hr for a composite cycle test was repeated for 540 cycles, then rust-proofing treatment was applied and the corrosion depths of the soldered part and stay fitting contact crevice part were found by the microscope focal depth method.

Note that said plated steel sheet was treated by chromate. The weight was made 20 mg/m². Further, part of the cut samples were painted by cationic electrodeposition. As the paint, PN-110 made by Nippon Paint was used. The film thickness was made 25 μm.

Details of the test material and the test results are shown in Table 8. Comparative Example No. 205 had a Ti content not satisfying the requirements of the present invention, so the soldered heat affected zone was insufficient in corrosion resistance. Further, Comparative Example No. 304 had a Cr content outside the scope of the present invention, so sufficient corrosion resistance was not obtained. Comparative Example Nos. 301, 302, and 303 had steel ingredients satisfying the requirements of the present invention, but had weights of the corrosion-proof plating outside the scope of the present invention, so satisfactory corrosion resistances could not be obtained. Comparative Example No. 305 had a composition of the corrosion-proof plating and a weight outside the scope of the present invention, so a satisfactory corrosion resistance could not be obtained. On the other hand, the Invention Example Nos. 101 to 116 had both steel ingredients and plating weights satisfying the requirements of the present invention. Regardless of any cationic electrodeposition painting, satisfactory corrosion resistances could not be obtained.

TABLE 8

| | | | | | | Salt corrosion | |
|---|---|---|---|---|---|---|---|
| | | | | | | resistance*) | |
| | | | | | | | Local |
| | | | | | | | corrosion |
| | | | | | | | of inside |
| | | | | | Cationic | Local | of contact |
| | | | | Plating | electro- | corrosion of | crevices |
| | | | Plating | weight | deposition | soldered heat | of stay |
| Class | No. | Steel | composition | (g/m²) | painting | affected zone | fitting |
| Inv. ex. | 101 | A | Sn | 35 | No | Good | Good |
| | 102 | A | Sn | 35 | No | Good | Good |
| | 103 | A | Sn—1.0% Zn | 40 | Yes | Good | Good |
| | 104 | A | Sn—8.0% Zn | 38 | Yes | Good | Good |
| | 105 | A | Sn—9.9% Zn | 75 | No | Good | Good |
| | 106 | A | Sn | 8 | No | Good | Good |
| | 107 | A | Sn | 35 | No | Good | Good |
| | 108 | A | Sn | 40 | No | Good | Good |
| | 109 | B | Sn | 35 | Yes | Good | Good |
| | 110 | B | Sn—1.0% Zn | 35 | Yes | Good | Good |
| | 111 | B | Sn—8.0% Zn | 35 | No | Good | Good |
| | 112 | B | Sn—9.9% Zn | 35 | No | Good | Good |
| | 113 | C | Sn | 35 | No | Good | Good |
| | 114 | C | Sn—1.0% Zn | 35 | No | Good | Good |
| | 115 | C | Sn—8.0% Zn | 35 | No | Good | Good |
| | 116 | C | Sn—9.9% Zn | 35 | No | Good | Good |
| Co. ex. | 205 | E | Sn—8.0% Zn | 35 | No | Poor | Good |
| | 301 | A | Sn | 8 | No | Poor | Poor |
| | 302 | B | Sn | 8 | Yes | Poor | Poor |
| | 303 | C | Sn—8.0% Zn | 8 | No | Poor | Poor |
| | 304 | D | Sn—8.0% Zn | 35 | Yes | Poor | Poor |
| | 305 | C | Sn—14.8% Zn | 35 | No | Poor | Poor |

Underlined parts: Outside scope of present invention.
*)Good: Ratio of maximum corrosion depth to original thickness of 50% or less Poor: Ratio of maximum corrosion depth to original thickness of over 50%

### INDUSTRIAL APPLICABILITY

As explained above, according to the present invention, surface treated stainless steel sheet for a fuel tank and for a fuel pipe with excellent corrosion resistance and weld zone reliability under a salt environment and surface treated stainless steel welded pipe for an automobile fuel inlet pipe with excellent salt corrosion resistance, weld zone reliability, and pipe expandability are obtained, so the industrial effect is large.

1. Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.030%, Si: ≦2.00%, Mn: ≦2.00%, P: ≦0.050%, S: ≦0.0100%, N: ≦0.030%, Al: 0.010 to 0.100%, and Cr: 10.00 to 25.00%, further containing one or more of Ni: 0.10 to 4.00%, Cu: 0.10 to 2.00%, Mo: 0.10 to 2.00%, and V: 0.10 to 1.00% and one or both of Ti: 0.01 to 0.30% and Nb: 0.01 to 0.30%, having a balance of unavoidable impurities and Fe, having a Y-value defined by formula (1) of −10.4 or less, on the surface of which is provided a corrosion-proof plating layer comprised of Sn and unavoidable impurities in a weight of 10 g/m² to 200 g/m²:
Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

2. Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.030%, Si: ≦2.00%, Mn: ≦2.00%, P: ≦0.050%, S: ≦0.0100%, N: ≦0.030%, Al: 0.010 to 0.100%, and Cr: 10.00 to 25.00%, further containing one or more of Ni: 0.10 to 4.00%, Cu: 0.10 to 2.00%, Mo: 0.10 to 2.00%, and V: 0.10 to 1.00% and one or both of Ti: 0.01 to 0.30% and Nb: 0.01 to 0.30%, having a balance of unavoidable impurities and Fe, and having a Y-value defined by formula (1) of −10.4 or less, on the surface of which is provided a corrosion-proof plating layer comprised of Zn: 0.8 to 10.0% and a balance of Sn and unavoidable impurities in a weight of 10 g/m² to 200 g/m²:
Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

3. Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦1.00%, Mn: ≦1.00%, P: ≦0.050%, S: ≦0.0100%, N: ≦0.0200%, Al: 0.010 to 0.100%, and Cr: 10.00 to 25.00%, further containing one or both of Ti and Nb satisfying (Ti+Nb)/(C+N): 5.0 to 30.0, having a balance of unavoidable impurities and Fe, and having a Y-value defined by formula (1) of −10.4 or less, on the surface of which is provided a corrosion-proof plating layer comprised of Sn and unavoidable impurities in a weight of 10 g/m² to 200 g/m²:
Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

4. Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦1.00%, Mn: ≦1.00%, P: ≦0.050%, S: ≦0.0100%, N: ≦0.0200%, Al: 0.010 to 0.100%, and Cr: 10.00 to 25.00%, further containing one or both of Ti and Nb satisfying (Ti+Nb)/(C+N): 5.0 to 30.0, having a balance of unavoidable impurities and Fe, and having a Y-value defined by formula (1) of −10.4 or less, on the surface of which is formed a corrosion-proof plating layer comprised of Zn: 0.8 to 10.0% and a balance of Sn and unavoidable impurities by the hot dipping method in a weight of 10 g/m² to 200 g/m²:
Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

5. Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦0.60%, Mn: ≦0.60%, P: ≦0.040%, S: ≦0.0050%, N: ≦0.0150%, Al: 0.010 to 0.100%, and Cr: 10.00 to 25.00%, further containing one or more of Ti and Nb satisfying (Ti+Nb)/(C+N): 5.0 to 30.0, having a balance of unavoidable impurities and Fe, and having a Y-value defined by formula (1) of −10.4 or less, on the surface of which is provided a corrosion-proof plating layer comprised of Sn and unavoidable impurities in a weight of 10 g/m² to 200 g/m²:
Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

6. Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦0.60%, Mn: ≦0.60%, P: ≦0.040%, S: ≦0.0050%, N: ≦0.0150%, Al: 0.010 to 0.100%, and Cr: 10.00 to 25.00%, further containing one or both of Ti and Nb satisfying (Ti+Nb)/(C+N): 5.0 to 30.0, having a balance of unavoidable impurities and Fe, and having a Y-value defined by formula (1) of −10.4 or less, on the surface of which is provided a corrosion-proof plating layer comprised of Zn: 0.8 to 10.0% and a balance of Sn and unavoidable impurities in a weight of 10 g/m² to 200 g/m²:
Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

7. Surface treated stainless steel sheet for an automobile fuel tank and for an automobile fuel pipe with excellent corrosion resistance and weld zone reliability in a salt environment comprised of the stainless steel sheet substrate as set forth in claim 1 further containing, by mass %, B: 0.0002 to 0.0020%.

8. Surface treated stainless steel sheet for an automobile fuel tank and for an automobile fuel pipe with excellent corrosion resistance and weld zone reliability in a salt environment comprised of the stainless steel sheet substrate as set forth in claim 2 further containing, by mass %, B: 0.0002 to 0.0020%.

9. Surface treated stainless steel sheet for an automobile fuel tank and for an automobile fuel pipe with excellent corrosion resistance and weld zone reliability in a salt environment comprising a stainless steel sheet substrate containing, by mass %, containing C: ≦0.0100%, Si: ≦0.60%, Mn: ≦0.60%, P: ≦0.040%, S: ≦0.0050%, N: ≦0.0150%, Al: 0.010 to 0.100%, and Cr: 10.00 to 25.00%, further containing one or more of Ti and Nb satisfying (Ti+Nb)/(C+N): 5.0 to 30.0, having a balance of unavoidable impurities and Fe, having a Y-value defined by formula (1) of −10.4 or less, having a ferrite single phase metal structure, having an average r-value of 1.4 or more, and having a total elongation of 30% or more, on the surface of which is provided a corrosion-proof plating layer comprised of Sn and unavoidable impurities in a weight of 10 g/m² to 200 g/m²:
Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

10. Surface treated stainless steel sheet for an automobile fuel tank and for an automobile fuel pipe with excellent corrosion resistance and weld zone reliability in a salt environment comprising a stainless steel sheet substrate containing, by mass %, C: ≦0.0100%, Si: ≦0.60%, Mn: ≦0.60%, P: ≦0.040%, S: ≦0.0050%, N: ≦0.0150%, Al: 0.010 to 0.100%, and Cr: 10.00 to 25.00%, further containing one or both of Ti and Nb satisfying (Ti+Nb)/(C+N): 5.0 to 30.0, having a balance of unavoidable impurities and Fe, having a Y-value defined by formula (1) of −10.4 or less, having a ferrite single phase metal structure, having an average r-value of 1.4 or more, and having a total elongation of 30% or more, on the surface of which is provided a corrosion-proof plating layer comprised of Zn: 0.8 to 10.0% and a balance of Sn and unavoidable impurities in a weight of 10 g/m² to 200 g/m²:
Y=3.0[Ni]+30[C]+30[N]+0.5[Mn]+0.3[Cu]−1.1[Cr]−2.6[Si]−1.1[Mo]−0.6([Nb]+[Ti])−0.3([Al]+[V]) Formula (1)

11. Surface treated stainless steel sheet for an automobile fuel tank and for an automobile fuel pipe with excellent corrosion resistance and weld zone reliability in a salt environment as set forth in claim 1, characterized in that said corrosion-proofing layer has a chemical conversion film formed on it.

12. Surface treated stainless steel sheet for an automobile fuel tank and for an automobile fuel pipe with excellent corrosion resistance and weld zone reliability in a salt environment as set forth in claim 1, characterized in that said corrosion-proofing layer or chemical conversion film has a water soluble lubrication film with a friction coefficient of 0.15 or less formed on it.

13. Surface treated stainless steel welded pipe for an automobile fuel inlet pipe with excellent pipe expandability comprised of welded pipe made of surface treated stainless steel sheet as set forth in claim 9 having a hardness difference ΔHv (=HV_{W}−Hv_{M}) of a Vicker's hardness Hv_{W} of a weld zone and a Vicker's hardness Hv_{M} of a matrix material of 10 to 40 in range and having a ratio RT (=T_{W}/T_{M}) of a bead thickness T_{W} of the weld zone and a wall thickness T_{M} of the matrix material of 1.05 to 1.3.

14. Surface treated stainless steel welded pipe for an automobile fuel inlet pipe with excellent pipe expandability as set forth in claim 13, characterized in that the welded pipe after shaping, welding, and straightening has a circumferential direction elongation of the matrix material of 15% or more.
